(19) United States
(12) Patent Application Publication
(10) Pub. No.: US 2016/0127154 A1
(43) Pub. Date: May 5, 2016

(54) TRANSMITTING DEVICE, RECEIVING DEVICE, COMMUNCATION SYSTEM AND INTERPOLATION METHOD

(71) Applicant: SHARP KABUSHIKI KAISHA, Osaka-shi, Osaka (JP)

(72) Inventors: Alvaro RUIZ DELGADO, Osaka-shi (JP); Minoru KUBOTA, Osaka-shi (JP); Hiromichi TOMEBA, Osaka-shi (JP); Takashi ONODERA, Osaka-shi (JP)

(21) Appl. No.: 14/412,013

(22) PCT Filed: Jun. 5, 2013
(86) PCT No.: PCT/JP2013/066130

§ 371 Date: Dec. 30, 2014

(30) Foreign Application Priority Data
Jul. 5, 2012 (JP) 2012-151902

(51) Int. Cl. H04L 25/02; H04L 1/00

(52) U.S. Cl. CPC H04L 25/0234; H04L 25/022; H04L 1/0026

(57) ABSTRACT

A transmitting device in a wireless communication includes a control module configured to indicate a method out of a plurality of interpolation methods, each of which interpolates channel values in missing subcarriers based on positions of representative subcarriers, which are selected out of the subcarriers defining a frequency band used in the wireless communication, and values in the representative subcarriers, and a transmitting module configured to transmit information about a selected interpolation method.

### BACKGROUND OF THE INVENTION

1. Field of the Invention

The present invention relates to a transmitting device, a receiving device, a wireless communication system and interpolation methods used in wireless communications.

2. Description of the Related Art

MIMO (Multiple Input-Multiple Output) technology in wireless communications uses multiple transmit and receive antennas to improve communication performance. MIMO provides a variety of SU-MIMO (Single-User MIMO) and MU-MIMO (Multi-User MIMO). MISO (Multiple Input-Single Output), SIMO (Single Input-Multiple Output) and SISO (Single Input-Single Output) are degenerate cases of MIMO. MIMO may be combined with OFDM (Orthogonal Frequency-Division Multiplexing) or OFDMA (Orthogonal Frequency-Division Multiple Access) to handle efficiently the problems created by multi-paths. In OFDM, a large number of closely spaced orthogonal sub-carriers are used to carry data.

MIMO uses precoding as described in M. Joham, J. Brehmer and W. Utschick, “MMSE Approaches to Multiuser Spatio-Temporal Tomlinson-Harashima Precoding” Proc. 5th Int. ITG Conf. on Source and Channel Coding, pp. 387-394, January, 2004). Precoding involves multiple data streams being emitted simultaneously on the same subcarrier from transmit antennas with independent and appropriate weightings such that throughput (average rate of successful message delivery over a communication channel) is maximized at receive antennas. In a closed loop MIMO, the transmitting device must be informed about the channel. Therefore, the transmitting device sends sounding reference signals carried by subcarriers to a receiving device. The receiving device estimates the channel states using them and sends back CSI (Channel State Information) to the transmitting device, which then precodes MIMO data to make beamformed data signals.

In Table 14 of “IEEE P802.11 Wireless LAN Specification Framework for TGac”, IEEE 802.11-09/0992r21, January, 2011, it is described that a receiving device sends channel matrix on every second or fourth subcarrier when Grouping Ng is 2 or 4.

According to the technique disclosed in “IEEE P802.11 Wireless LAN Specification Framework for TGac”, IEEE 802.11-09/0992r21, January, 2011, it would be expected to improve throughput because the channel state information conveyed by a feedback frame is reduced. However, the transmitter needs to interpolate the channel values in missing subcarriers to precode MIMO data, and furthermore channel characteristics changes moment by moment. It could not be possible to improve the throughput as expected by the technique disclosed in “IEEE P802.11 Wireless LAN Specification Framework for TGac”, IEEE 802.11-09/0992r21, January, 2011, since the channel characteristics could not be adequately recovered and the interference between streams remains.

### SUMMARY OF THE INVENTION

One of the technical advantages achieved by the preferred embodiments of the present invention is improving and optimizing recovery of channel characteristics using reduced channel state information conveyed by a feedback frame. Other advantages will become apparent from the following descriptions of the preferred embodiments of the present invention.

According to a preferred embodiment of the present invention, a transmitting device in a wireless communication includes a control module configured to indicate a method out of a plurality of interpolation methods, each of which interpolates channel values in missing subcarriers based on positions of representative subcarriers, which are selected out of the subcarriers constituting a frequency band used in the wireless communication, and the values in the representative subcarriers, and a transmitting module configured to transmit information about the selected interpolation method.

Additionally, the transmitting device according to a preferred embodiment of the present invention is configured to transmit the information about the selected interpolation method according to a channel state between the transmitting device and receiving devices.

Further, according to another preferred embodiment of the present invention, a transmitting device in a wireless communication includes a control module configured to indicate several methods out of a plurality of interpolation methods, each of which interpolates channel values in missing subcarriers based on positions of representative subcarriers, which are selected out of the subcarriers constituting a frequency band used in the wireless communication, and values in the representative subcarriers, and a transmitting module configured to transmit information about the several interpolation methods selected.

Further, according to a further preferred embodiment of the present invention, a receiving device in a wireless communication includes a reception module configured to receive information about several interpolation methods, each of which interpolates channel values in missing subcarriers based on positions of representative subcarriers, which are selected out of subcarriers constituting a frequency band used in the wireless communication, and values in the representative subcarriers, and an interpolation choice module configured to select a method out of the several interpolation methods.

Further, according to yet another preferred embodiment of the present invention, a transmitting device in a wireless communication between the transmitting device and a plurality of receiving devices includes a control module configured to indicate in every receiving device a method selected out of a plurality of interpolation methods, each of which interpolates channel values in missing frequency points based on positions of representative subcarriers, which are selected out of the subcarriers constituting a frequency band used in the wireless communication, and values in the representative subcarriers, and a transmission module configured to transmit the selected interpolation methods.

Additionally, the transmitting device according to a preferred embodiment of the present invention preferably is configured to transmit information about a maximum and/or a minimum of a number of representative subcarriers.

Additionally, the transmitting device according to a preferred embodiment of the present invention preferably is configured to transmit information about a quality of feedback from the receiving device to the transmitting device.

Further, according to another preferred embodiment of the present invention, a wireless communication system includes a transmitting device and a plurality of receiving devices including a first receiving device configured to perform an interpolation optimized feedback of representative subcarriers, which are selected out of subcarriers constituting a frequency band used in the wireless communication, to optimize recovery of channel characteristics using reduced channel state information conveyed by a feedback frame, and a second receiving device which does not perform the interpolation optimized feedback.

Further, according to a further preferred embodiment of the present invention, a receiving device in a wireless communication includes an optimum selection module configured to select representative subcarriers out of subcarriers constituting a frequency band used in the wireless communication at irregular intervals.

Further, according to an additional preferred embodiment of the present invention, an interpolation method used in a wireless communication includes identifying representative subcarriers, selected out of subcarriers defining a frequency band used in the wireless communication, to channel values, finding slopes of channel characteristics in the representative subcarriers, and interpolating channel values in missing points by the channel values, slopes and positions in the representative subcarriers.

According to various preferred embodiments of the present invention, channel characteristics are greatly improved or optimized by the reduced channel state information conveyed by a feedback frame.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram of an exemplary wireless communication system according to a preferred embodiment of the present invention.

FIG. 2 is a protocol of the communication in FIG. 1.

FIG. 3A shows an example of VHT Capabilities field in a beacon according to a preferred embodiment of the present invention.

FIG. 3B shows an example of VHT Capabilities field in a beacon according to a preferred embodiment of the present invention.

FIG. 3C shows a table of supported interpolation according to a preferred embodiment of the present invention.

FIG. 4A shows the structure of NDPA according to the first preferred embodiment of the present invention.

FIG. 4B shows the structure of NDPA according to the first preferred embodiment of the present invention.

FIG. 5 is the structure of NDP according to the first preferred embodiment of the present invention.

FIG. 6A shows the structure of SND FB according to a preferred embodiment of the present invention.

FIG. 6B shows the structure of SND FB according to a preferred embodiment of the present invention.

FIG. 6C shows an illustrative configuration for Quantization according to a preferred embodiment of the present invention.

FIG. 7A shows one configuration of Number of subcarriers according to a preferred embodiment of the present invention.

FIG. 7B shows another configuration according to a preferred embodiment of the present invention.

FIG. 7C shows another configuration according to a preferred embodiment of the present invention.

FIG. 7D shows another configuration according to a preferred embodiment of the present invention.

FIG. 7E shows another configuration according to a preferred embodiment of the present invention.

FIG. 8 is the structure of FB Poll according to the first preferred embodiment of the present invention.

FIG. 9 is a schematic block diagram of an access point according to the first preferred embodiment of the present invention.

FIG. 10 is the example of a precoding module according to a preferred embodiment of the present invention.

FIG. 11 is a flowchart showing the procedure of a central value interpolation according to a preferred embodiment of the present invention.

FIG. 12 is a flowchart showing the procedure of a linear interpolation according to a preferred embodiment of the present invention.

FIG. 13 is a flowchart showing the procedure of a cubic interpolation according to a preferred embodiment of the present invention.

FIG. 14 is a flowchart showing the procedure according to a preferred embodiment of the present invention in which slopes of the channel characteristic are calculated.

FIG. 15 is a schematic block diagram of the station according to the first preferred embodiment of the present invention.

FIG. 16 is a flowchart showing the procedure in which the selection of representative frequency points is performed.

FIG. 17 is a graph providing a supplementary explanation of the procedure of FIG. 16.

FIG. 18 is a flowchart showing the procedure according to a preferred embodiment of the present invention, in which the incremental mapping is calculated.

FIG. 19 is a table of incremental mapping according to a preferred embodiment of the present invention.

FIG. 20A shows tables of supported interpolations according to the second preferred embodiment of the present invention.

FIG. 20B shows tables of supported interpolations according to the second preferred embodiment of the present invention.

FIG. 21A shows the details of VHT MIMO Control according to the second preferred embodiment of the present invention.

FIG. 21B shows tables of interpolation according to a preferred embodiment of the present invention.

FIG. 21C shows tables of interpolation according to a preferred embodiment of the present invention.

FIG. 22 is a schematic block diagram of the access point according to the second preferred embodiment of the present invention.

FIG. 23 is a schematic block diagram of the station according to the second preferred embodiment of the present invention.

FIG. 24 is a flowchart showing the procedure to choose an interpolation method and then to select representative points at the station according to a preferred embodiment of the present invention.

FIG. 25 is the structure of NDPA according to the third preferred embodiment of the present invention.

FIG. 26A shows an interpolation choice aid of NDPA shown in FIG. 25.

FIG. 26B shows an interpolation choice aid of NDPA shown in FIG. 25.

FIG. 26C shows an interpolation choice aid of NDPA shown in FIG. 25.

FIG. 26D shows an interpolation choice aid of NDPA shown in FIG. 25.

FIG. 27 is a flowchart explaining the actions of interpolation adaptation at a station according to a preferred embodiment of the present invention.

FIG. 28 shows a structure of NDPA according to the fourth preferred embodiment of the present invention.

FIG. 29 is a flowchart showing the function of a station according to the fifth preferred embodiment of the present invention.

### DETAILED DESCRIPTION OF THE PREFERRED EMBODIMENTS

Now, preferred embodiments of the present invention will be described in detail with reference to the annexed drawings. The preferred embodiments relate to a WLAN (Wireless Local Area Network), but they are not restricted to the WLAN, but are also applicable to a mobile phone network or any other type of communication network.

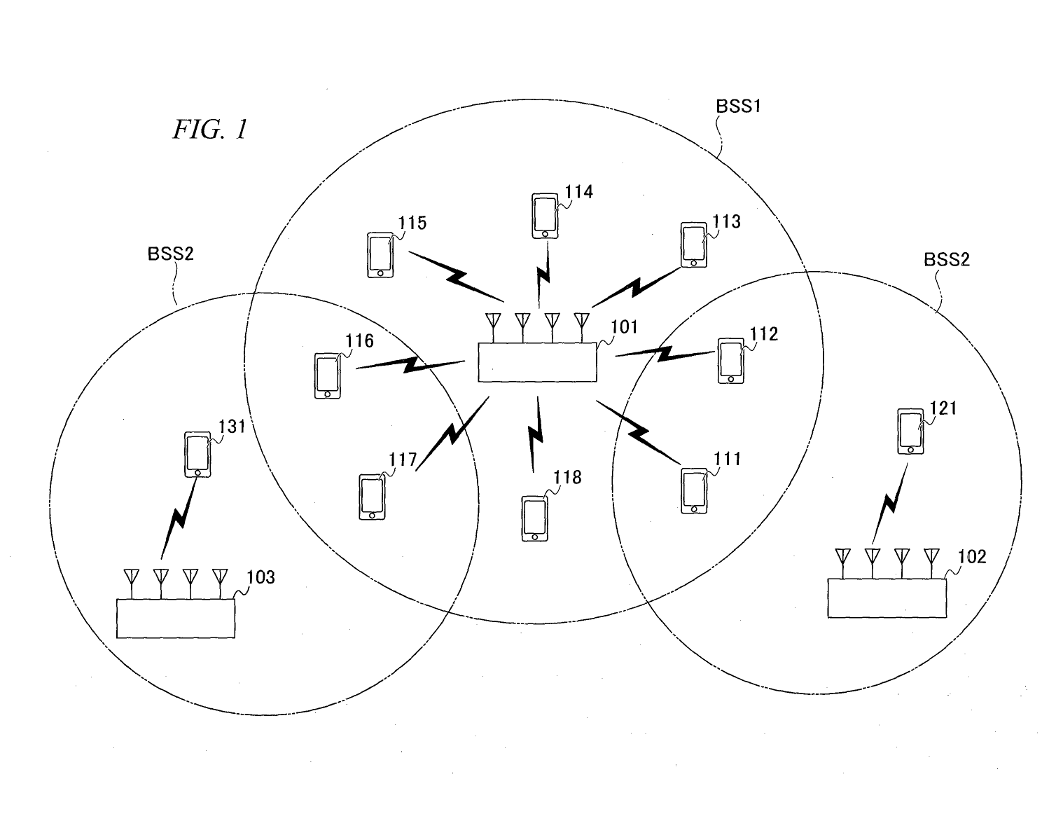

FIG. 1 is a block diagram of an exemplary wireless communication system according to a preferred embodiment of the present invention.

The system includes BSSs (Basic Service Sets) 1 to 3 which form wireless networks, respectively. BSS 1 preferably includes an access point 101 and stations 111 to 118. BSS 2 includes an access point 102 and stations 111, 112 and 121. BSS 3 includes an access point 103 and stations 116, 117 and 131.

Stations 111 to 118 are configured to receive a beacon from the access point 101. Stations 111, 112 and 121 are configured to receive a beacon from the access point 102. Stations 116, 117 and 131 are configured to receive a beacon from the access point 103. Stations 111 and 112 are configured to receive beacons from both of access points 101 and 102, respectively. Stations 116 and 117 are configured to receive beacons from both of access points 101 and 103, respectively. Either one or all of BSSs 1 to 3 may be connected to a WAN (Wide Area Network) which is not shown in FIG. 1.

In the following descriptions, an access point and a station may be abbreviated to AP and STA, respectively. An access point and stations may also be referred to as transmitting and receiving devices, respectively.

Each of access points 101 to 103 preferably includes n transmit antennas. Each of stations 111 to 118, 121 and 131 preferably includes m receive antennas. In FIG. 1, for example, four transmit antennas of each of access points 101 to 103 and one receive antenna of each of stations 111 to 118, 121 and 131 are depicted in FIG. 1 in order to make the drawing clear and simple.

For example, the access point 101 communicates four stations 111 to 114. In SU-MIMO, for example, the access point 101 includes four transmit antennas and each of stations 111 to 1114 includes four receive antennas. In that case, the four transmit antennas emit streams and the four receive antennas of any one of stations 111 to 114 receive four streams, respectively. Access point 101 communicates with one of stations 111 to 114 at once, and then it communicates with another station successively.

In MU-MIMO, for example, access point 101 preferably includes four transmit antennas, and each of stations 111 to 1114 preferably includes one receive antenna. The four transmit antennas of access point 101 emit streams and one receive antenna of each of stations 111 to 1114 receives the stream that is directed to itself.

The above-mentioned numbers of antennas are only non-limiting examples. The present preferred embodiments are applicable to, for example, MISO, SIMO and SISO, and are even applicable to a wired network.

In MU-MIMO, a station may even include multiple receive antennas, for example. In SU-MIMO, the number m of receive antennas of the station may be even larger or smaller than the number n of transmit antennas of the access point.

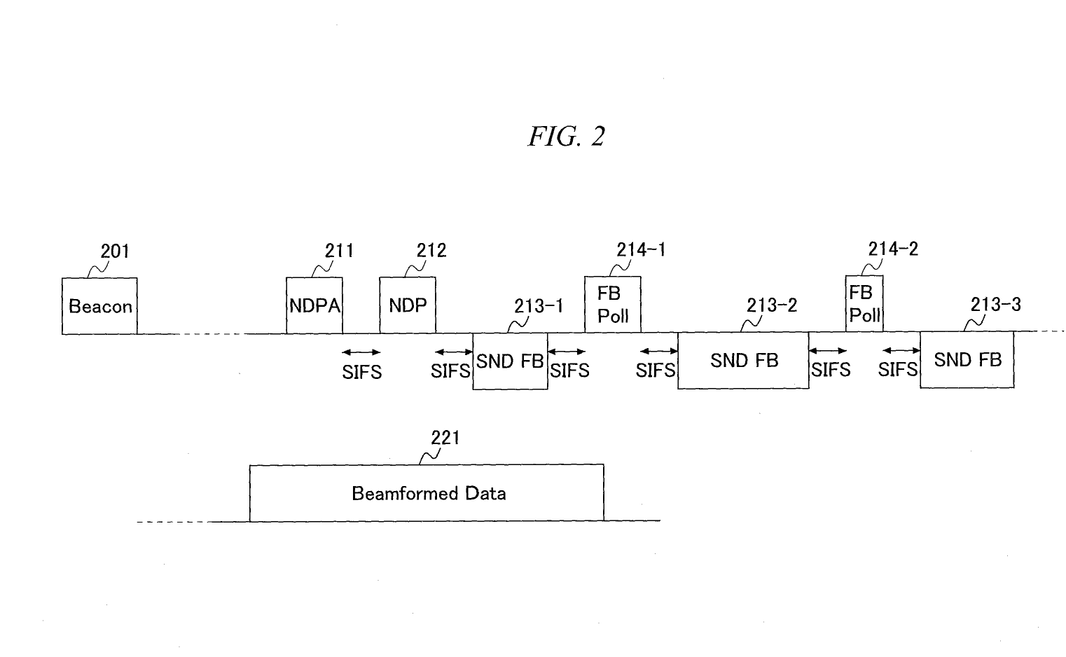

FIG. 2 is a protocol of the communication in FIG. 1. Access point 101 periodically transmits Beacon 201 to inform stations 111 to 118. Stations 111 to 118 are configured to detect and identify Beacon 201 and examine parameters to join the network respectively.

After sending Beacon 201 and before sending the next, access point 101 sends NDPA (No Data Packet Announce) 211. NDPA 211, like a beacon, is a control frame and designates one of the stations 111 to 118 which responds first. NDPA 211 may specify another station which responds next. Access point 101 sends NDP (No Data Packet) 212 after SIFS (Short Inter-Frame Space). NDP 212 carries out the sounding of channels between the access point and stations. The sounding process starts with NDPA 211.

The station which responds first feeds back SND FB (Sounding Feedback) 213-1 after SIFS. The result of the sounding is written in a data field of SND FB 213-1. After receiving SND FB 213-1, access point 101 is configured to sends FB Poll (Feedback Polling) 214-1 after SIFS. The station which responds second feeds back SND FB 213-2 after SIFS. After receiving SND FB 213-2, the access point 101 sends FB Poll 214-2 after SIFS. The station which responds third feeds back SND FB 213-3 after SIFS. The above process continues until station 118 responds.

After the sounding sequence, access point 101 sends Beamformed Data 221. Beamformed Data 221 includes any of the text data, audio data, still image data, moving image data, etc.

In the following, SND FB 213-1 to SND FB 213-3 are named SND FB and FB Poll 214-1 to FB Poll 214-2 are named FB Poll 214 generically.

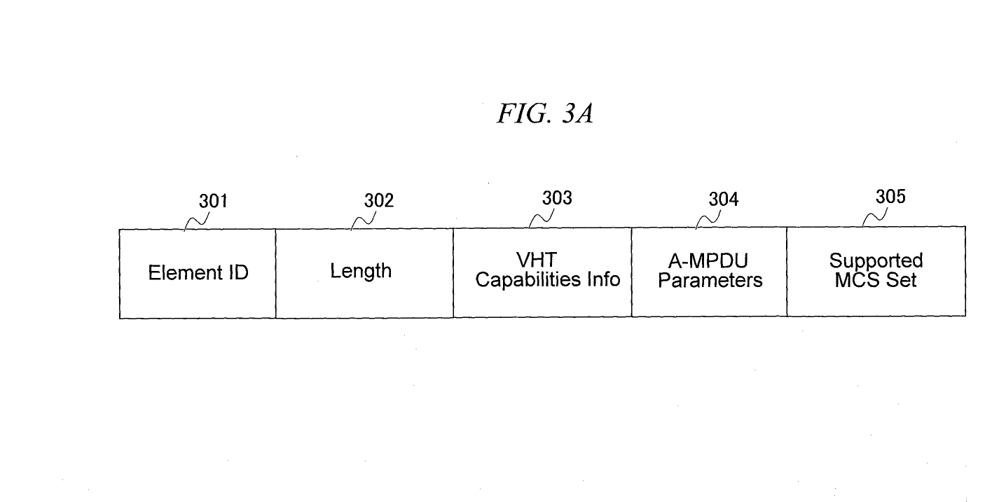

FIGS. 3A and 3B shows an example of VHT Capabilities field in a beacon. Any station that intends to connect to an access point reads the beacon in order to know the capabilities of the access point.

In FIG. 3A, Element ID 301 indicates that the elements to follow correspond to VHT Capabilities element. Length 302 gives the length of VHT Capabilities element. VHT Capabilities Info 303 specifies the capabilities of the access point 101. A-MPDU Parameters 304 indicates the maximum length of aggregated MPDU (MAC Protocol Data Unit) which a station can receive. Supported MCS Set 305 is used to convey the combinations of MCSs (Modulation and Coding Sets) which a station supports for both reception and transmission.

FIG. 3B shows VHT Capabilities Info 303 in more detail. In FIG. 3B, Maximum MPDU Length 311 indicates the maximum MPDU length. Supported Channel Width Set 312 indicates the bandwidth which a station supports. LDPC Coding Capabilities 313 is set to 0 if LDPC (Low Density Parity Check) is not supported, and to 1 if LDPC is supported. Short GI for 20/40/80/160 314 indicates support for receiving packets using the short guard interval in various bandwidths. Tx STBC 315 indicates support for the transmission of at least 2×1 STBC (Space-Time Block Coding). Rx STBC 316 indicates support for the reception of PPDU (PLCP Protocol Data Unit) using STBC. SU Beamformer Capable 317 indicates support for operation as single user beamformer. SU Beamformee Capable 318 indicates support for operation as single user beamformee.

Grouping Set 319 indicates acceptable values for the VHT MIMO Control Grouping parameter with sounding feedback. Compressed Steering Number of Beamformer Antennas Supported 320 indicates the maximum number of beamformer antennas which the beamformee can support when sending compressed beamforming feedback. Number of Sounding Dimensions 321 indicates the number of antennas used by the beamformer when sending beamformed transmissions. MU Tx Capable 322 indicates whether or not the station supports operation as an MU beamformer. MU Rx Capable 323 indicates whether or not the station supports operation as an MU beamformee. VHT TXOP PS 324 indicates whether or not the access point supports VHT TXOP power save mode for stations already in the cell, while it indicates whether or not the station is in VHT TXOP power save mode when trying to associate or re-associate to the access point.

Supported Interpolation 331 shows the interpolation method which access point 101 can support.

FIG. 3C shows a possible example of Supported Interpolation 331.

Access point 101 sets the field to ‘00’ if the interpolation method which access point 101 supports is a linear Interpolation. Access point 101 sets the field to ‘01’ if the interpolation method which access point 101 supports is a pchip Interpolation. The wording “pchip” is an abbreviation for piecewise cubic Hermit interpolation polynomial. Access point 101 sets the field to ‘10’ if the interpolation method which access point 101 supports is a cubic spline Interpolation. The value ‘11’ is reserved for future use in this example, although it could be assigned to a different interpolation method.

Supported Interpolation 331 reflects the interpolation method access point 101 prefers to process at that given time. Access point 101 can decide to downgrade the accuracy of the interpolation method if its resources are being used to a point in which the risk exists of not being able to perform all the required computations in time. Downgrading the performed interpolation method could grant some extra computational power to meet the time requirements when the number of users becomes large.

Turning back to FIG. 3B, Reserved 325 is reserved for future use.

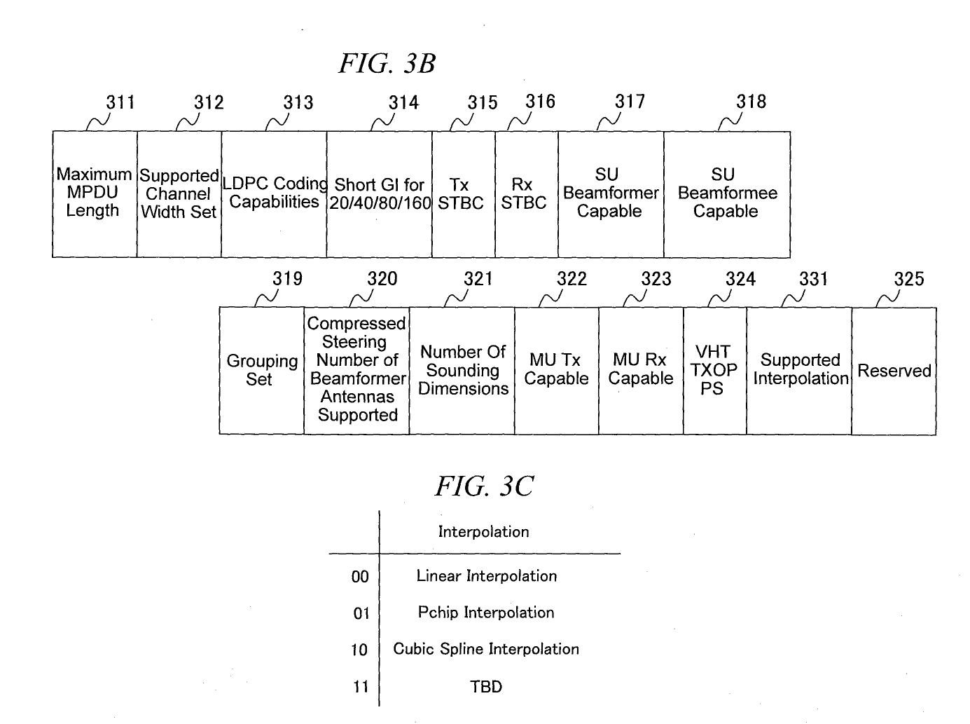

FIGS. 4A and 4B show the structure of NDPA 211. In FIG. 4A, Frame Control 401 identifies the frame as NDPA 211. Duration 402 indicates the duration of NDPA 211. RA 403 is set to the address of the destination in case of SU-MIMO, and to the broadcast address in case of MU-MIMO. TA 404 is set to the address of the access point. Sounding Sequence 405 indicates a sequence number associated to the current sounding sequence. STA Info 1 406-1, . . . , STA Info n 406-n contain the AID (Association Identifier) of the sounded stations respectively. AID is an indication of whether it is for SU MIMO or for MU MIMO, and in the latter case an indication of how many dimensions are requested. FCS 407 is a CRC of the previous fields in order to be able to detect errors.

NDPA 211 preferably contains a STA Info field for each of the station that must return its feedback right after the NDP 212, starting from the STA in the first STA Info field and continuing in order of appearance. In any case, after the access point has finished receiving the feedback from one station, the access point emits FB Poll 213 to state the identity of the next station to return its feedback.

FIG. 4B shows the structure of STA Info of FIG. 4A. In FIG. 4B, AID 411 contains an association identifier by which the addressed station is associated to the BSS. Feedback Type 412 is set to ‘0’ if the requested feedback is intended for SU-MIMO and is set to ‘1’ if the requested feedback is intended for MU-MIMO. Nc Index 413 is reserved in SU-MIMO, and it indicates the requested feedback dimension in MU-MIMO.

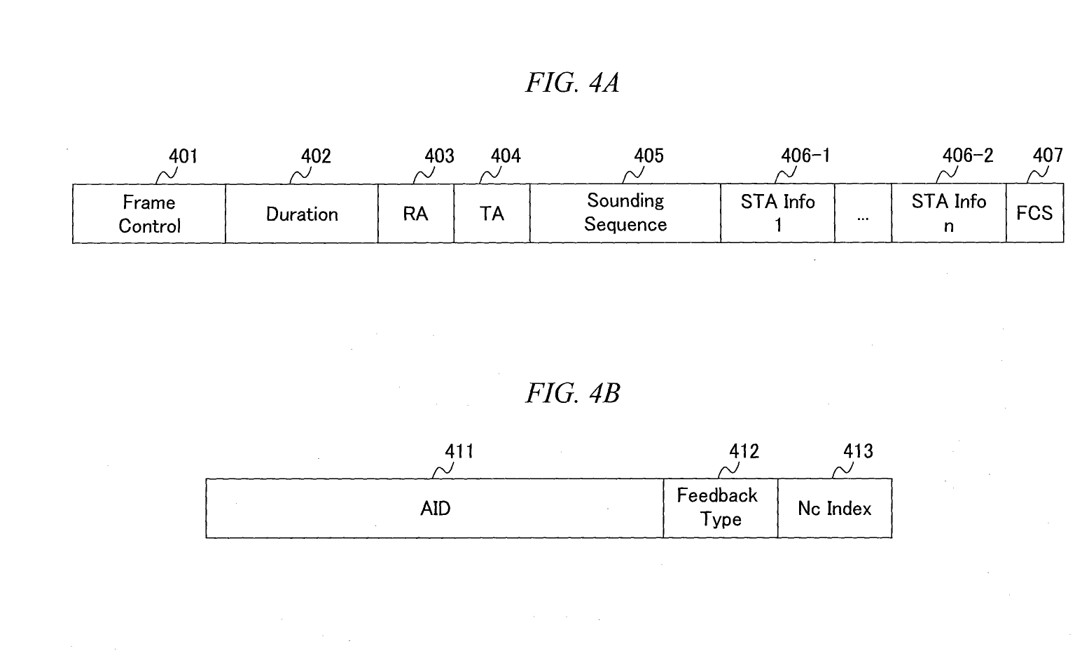

FIG. 5 shows the structure of NDP 212.

In FIG. 5, L-STF 501 corresponds to the legacy short training field. L-LTF 502 corresponds to the legacy long training field. L-SIG (Legacy-Signal) 503 gives information about the length of the packet. VHT-SIG-A 504a contains information about the packet and indicates whether it is an SU-MIMO or MU-MIMO transmission. VT-IT-SIG-A 504b gives additional information about the packet. VHT-STF 505 is an extension of the short training field for the VHT case. VHT-LTF1 506-1 serves for the station to estimate the channel from the first transmit antenna at the access point. Consequent VHT-LTF2 506-2 to VHT-LTFn 506-n allow the station to estimate the channel from the second transmit antenna to the n^{th} transmit antenna at the access point. VHT-SIG-B 507 is set to a fixed bit pattern known.

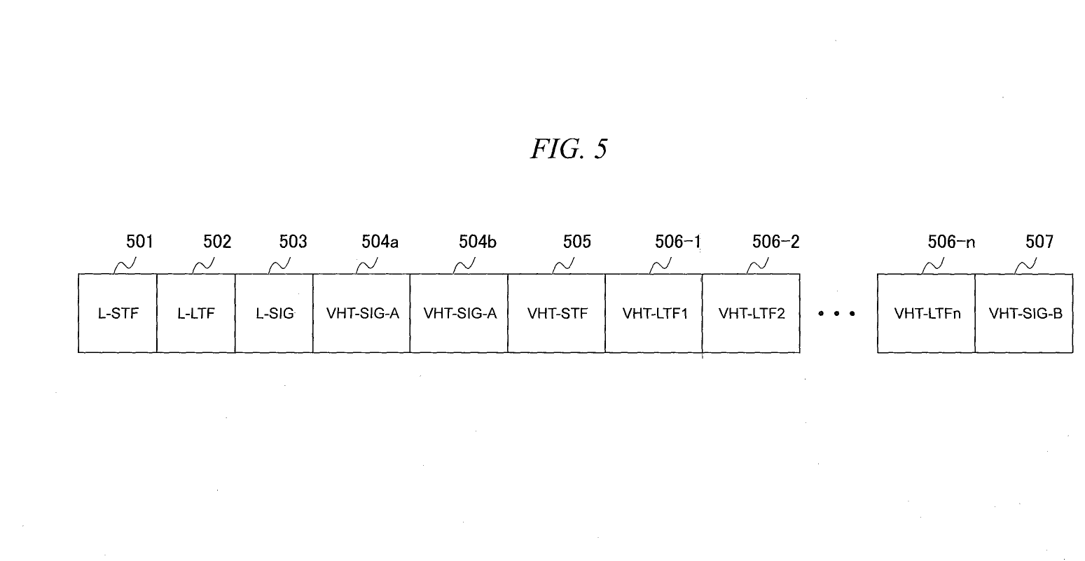

FIGS. 6A and 6B show the structure of SND FB.

In FIG. 6A, the whole frame format is specified for clarity, including Legacy Preamble 601, VHT Preamble 602, Service Field 603, VHT-DATA 604 and Tail & Padding 605.

VHT-DATA 604 is also known as MPDU (MAC Protocol Data Unit). VHT-DATA 604 contains MAC Header 611, Frame Body 612 and FCS (Frame Check Sequence) 613.

Next, MAC Header 611 will be explained.

Frame Control 621 contains some fields that identify the purpose of the frame, in this case as an action frame. Duration 622 gives the duration of the frame. Address 1 (DA (Destination Address)) 623 contains the destination address. SA (Source Address) 624 contains the address of the transmitting station. BSSID (Basic Service Set Identification) 625 identifies the BSS to which the frame belongs. Sequence Control 626 contains the identifier of the current sequence. VHT Control 627 contains information about the VHT MIMO configuration.

Next, Frame Body 612 will be explained.

Category 631 states that this action frame corresponds to VHT.

Action 632 indicates that the action is “Interpolation optimized feedback”. VHT MIMO Control 633 will be explained later. Number of subcarriers 634 states the number of representative subcarriers chosen for each stream.

Mapping 635 contains information about which representative frequency points the feedback is sent for. The mapping is created for the real and imaginary parts of the channel values. In this particular preferred embodiment, the mapping is an incremental mapping, for example.

VHT Beamforming Report 636 contains the quantized channel values in representative frequency points chosen for feedback. MU-Exclusive Beamforming Report 637 is present in the case of MU-MIMO, and gives additional information about the SNR affecting the different frequency points for each stream.

FIG. 6B details VHT MIMO Control 633.

In FIG. 6B, Nc Index 641 indicates the number of maximum space-time streams that the access point can use for beamforming. Nr Index 642 indicates the number of transmit antennas which the access point uses for beamforming. Channel Width 643 states the bandwidth for which the feedback is given. Reserved 644 is reserved for future use. Remaining Segments 645 indicates how many segments are to be sent after the current one. First Segment 646 is set to ‘1’ if the current segment is the first one of the sequence, and is set to ‘0’ otherwise.

FIG. 6C shows an illustrative configuration for Quantization 647.

If the field is set to ‘00’, the quantization is set to 4 bits for the real part and 4 bits for the imaginary part. If the field is set to ‘01’, the quantization is set to 5 bits for the real part and 5 bits for the imaginary part. If the field is set to ‘10’, the quantization is set to 6 bits for the real part and 6 bits for the imaginary part. If the field is set to ‘11’, the quantization is set to 7 bits for the real part and 7 bits for the imaginary part.

Turning back to FIG. 6B, Sounding Sequence Number 648 contains the identifier of the current sounding sequence.

Turning back to FIG. 6A, FCS 613 contains CRC to validate the integrity of the MPDU.

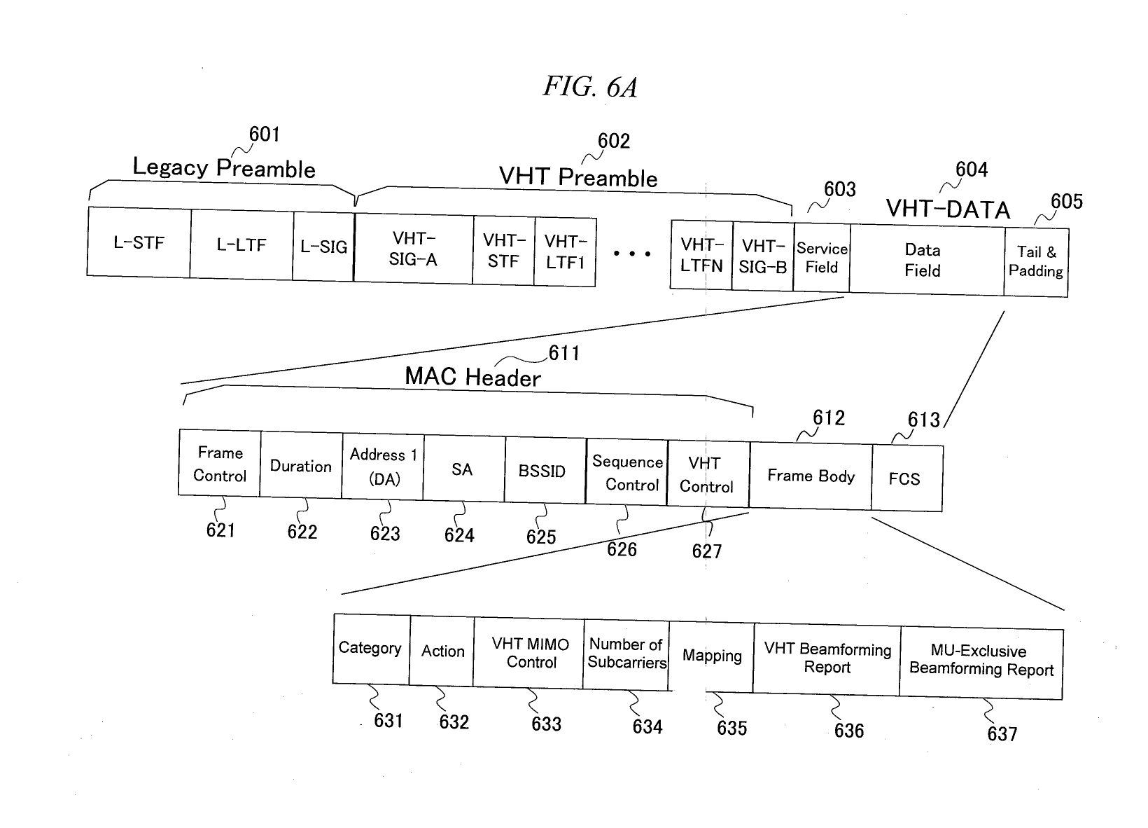

FIG. 7A shows a configuration of Number of Subcarriers 634.

In FIG. 7A, “SCs for stream 1, real part” 701-1a contains the number of representative frequency points (representative subcarriers) for the real part of the first stream. “SCs for stream 1, imaginary part” 701-1b preferably contains the number of frequency points for the imaginary part of the first stream. Segment 701-2a contains the number of representative frequency points for the real part of the second stream. Segment 701-2b preferably contains the number of frequency points for the imaginary part of the second stream. This configuration continues until stream n.

FIG. 7B is another configuration. The optimum number of chosen representative frequency points is usually the same or very close for the real and imaginary parts of each stream. This symmetry can be used by sending the same number for representative frequency points for both of real and imaginary parts.

In this case, “SCs for stream 1” 711-1 contains the number of representative frequency points sent for the first stream. “SCs for stream 1” 711-2 contains the number of representative frequency points sent for the second stream. This configuration continues until stream n.

FIG. 7C shows another configuration. In this case, the characteristics of the channel are similar for all the streams. The number of representative frequency points sent for each stream is very close or the same. In this example, the station computes the average number of chosen points sent for each stream, and sends that information as “Average SCs for all streams” 721.

“Offset for stream 1, real” 722-la is the difference between “Average SCs for all streams” 721 and the number of chosen subcarriers sent for the real part of the first stream. “Offset for stream 1, imaginary” 722-1b is the difference between “Average SCs for all streams” 721 and the number of chosen subcarriers sent for the imaginary part of the first stream. This configuration continues until stream n.

FIG. 7D shows another configuration In FIG. 7D, the average number of representative frequency points is sent and the offset for each stream is sent, but similar to FIG. 7B, real and imaginary parts are forced to use the same number of subcarriers.

FIG. 7E shows another configuration in which “SCs for all streams” 741 contains the same number of representative frequency points sent for each of the streams.

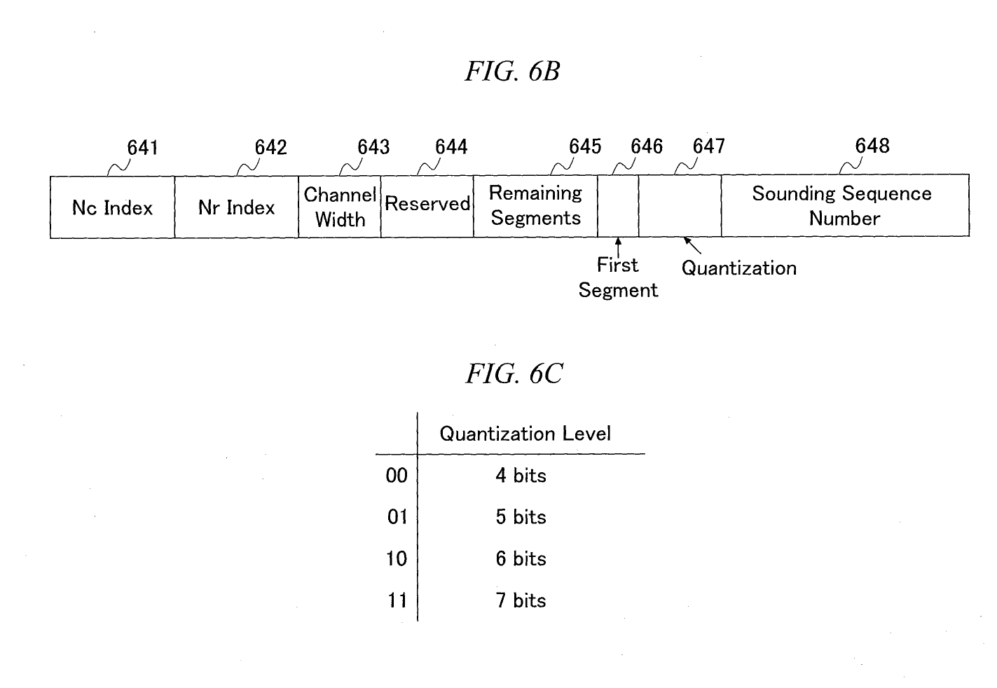

FIG. 8 shows the structure of FB Poll. In FIG. 8, Frame Control 801 indicates that the current frame is FB Poll. Duration 802 indicates the duration of FB Poll. RA 803 is set to the address of the station to send its feedback next. TA 804 is set to the address of the access point.

Segment Retransmission Bitmap 805 indicates which parts must be transmitted. FCS 806 is CRC of the previous fields in order to be able to detect errors.

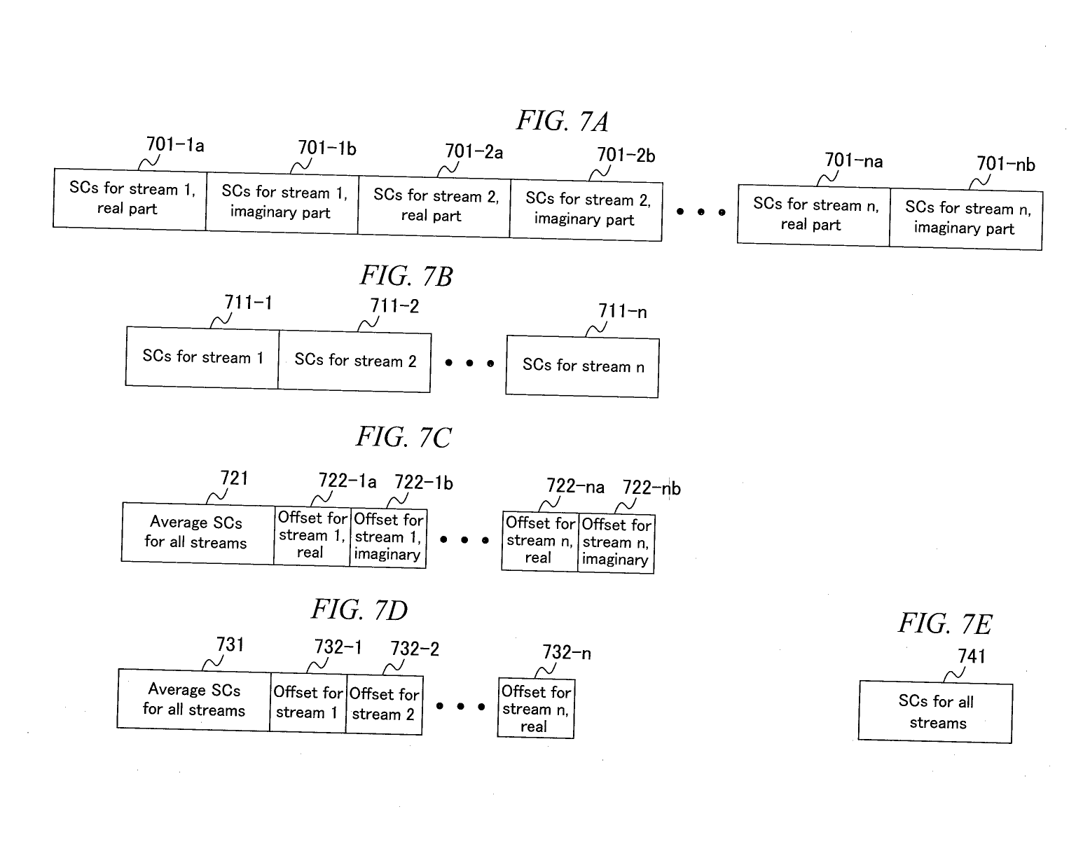

FIG. 9 is a schematic block diagram of the access point according to the first preferred embodiment.

In FIG. 9, Transmission Buffer module 901 is configured to receive data bits from an upper layer. The data bits preferably include the beacon, NDPA, NDP, FBPoll or Beamformed Data depicted in FIG. 2. Transmission Buffer module 901 is configured to store the data bits and then convey them to Coding modules 902-1 to 902-n as indicated by Selection module 914. Coding modules 902-1 to 902-n perform error correction coding to the data bits coming from Transmission Buffer module 901 as indicated by Selection module 915, respectively. Modulation modules 903-1 to 903-n perform modulations to the output signals from Coding modules 902-1 to 902-n indicated by Selection module 914, respectively.

Pilot multiplexing modules 904-1 to 904-n multiplex pilot signals (channel estimation signals) to the output signals from Modulation modules 903-1 to 903-n respectively when they include NDP.

Precoding module 905, having as input the modulated signals from Pilot Multiplexing modules 904-1 to 904-n, performs precoding to the input signals.

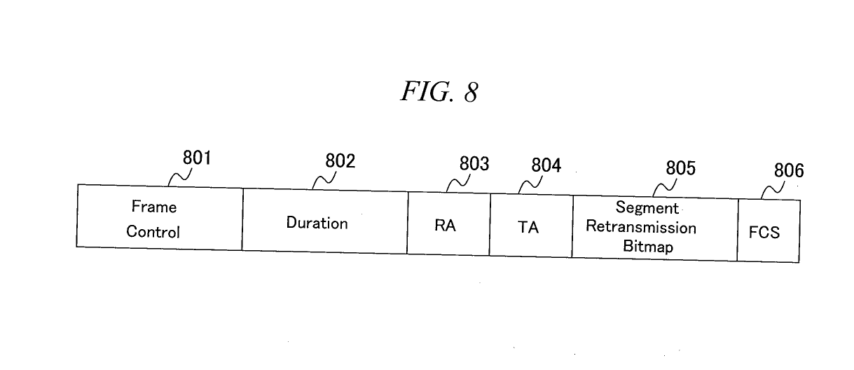

FIG. 10 shows the details of Precoding module 905. First, Filter Calculation module 1001 creates a filter W based on the channel matrices transferred from Feedback Storage module 915. The filter W may be a weighting matrix of Zero-Forcing, or the one obtained by MMSE criterion, for example.

Filter module 1002 is configured to multiply input signals from Pilot Multiplexing modules 904-1 to 904-n by filter W to make precoded signals which are output to IFFT (Inverse Fast Fourier Transform) modules 906-1 to 906-n, respectively. The multiplication is performed subcarrier by subcarrier.

If the signals input from Pilot Multiplexing modules 904-1 to 904-n to Precoding module 905, are the ones of a control frame like beacon, a unit matrix is selected as the filter W. According to this preferred embodiment, the signals bypass Precoding module 905.

Turning back to FIG. 9, IFFT modules 906-1 to 906-n change the precoded symbols to time domain signals, respectively. GI Insertion modules 907-1 to 907-n insert guard intervals in the time domain signals, respectively. Wireless transmission modules 908-1 to 908-n are configured to carry out DA conversion of the signals to which GI has been added to analogue signals, convert them to high frequency band and make transmissions from antennas 909-1 to 909-n, respectively.

Wireless reception module 910 is configured to receive SND FB depicted in FIG. 2 from a station. Wireless reception module 910 is configured to down convert it to baseband signals, and carry out AD conversion to obtain digital signals. Then, Wireless Reception module 910 is configured to convert the digital signals into frequency domain signals through FFT (Fast Fourier Transform), and sends them to Feedback Analyzer module 911.

Feedback Analyzer module 911 extracts the channel values in representative frequency points from VHT Beamforming Report 636 depicted in FIG. 6A and sends them to Feedback Interpolation module 913. Feedback Analyzer module 911 also extracts the positions of the representative frequency points from mapping 635 in FIG. 6A and sends them to Feedback Demapping 912. Feedback Analyzer module 911 extracts the number of subcarriers from Number of subcarriers 634 and sends it to Feedback Demapping module 912. Feedback Analyzer module 911 extracts the quantization level from Quantization 647 and sends it to Feedback Interpolation module 913.

Feedback Demapping module 912 is configured to de-map the positions of representative frequency points and gives this data to Feedback Interpolation module 913. The number of subcarriers sent from Feedback Analyzer 911 is used to check the operation of Feedback Demapping module 912. Feedback interpolation module 913 performs interpolation of the channel values in the missing points based on the information given by both of Feedback Demapping module 912 and Feedback Analyzer module 911. The number of quantization level sent from Quantization 647 is used to check the operation of Feedback interpolation module 913. Control module 916 indicates the interpolation method selected out of a plurality of interpolation methods. The channel values in the representative and missing points stream by stream are given to Selection module 914 and Feedback Storage module 916.

Selection module 914 is configured to receive information about the kinds and destinations of the data bits stored in Transmission Buffer module 901. Selection module 914 also receives information about the channels from Feedback Interpolation module 913. Selection module 914 decides which antenna paths the data bits stored in Transmission Buffer module 901 are to be directed to and sends the decision to Transmission Buffer module 901 and Feedback Storage module 915.

Feedback Storage module 915 reconstructs channel matrices based on the information received from Feedback Interpolation 913 and Selection module 915.

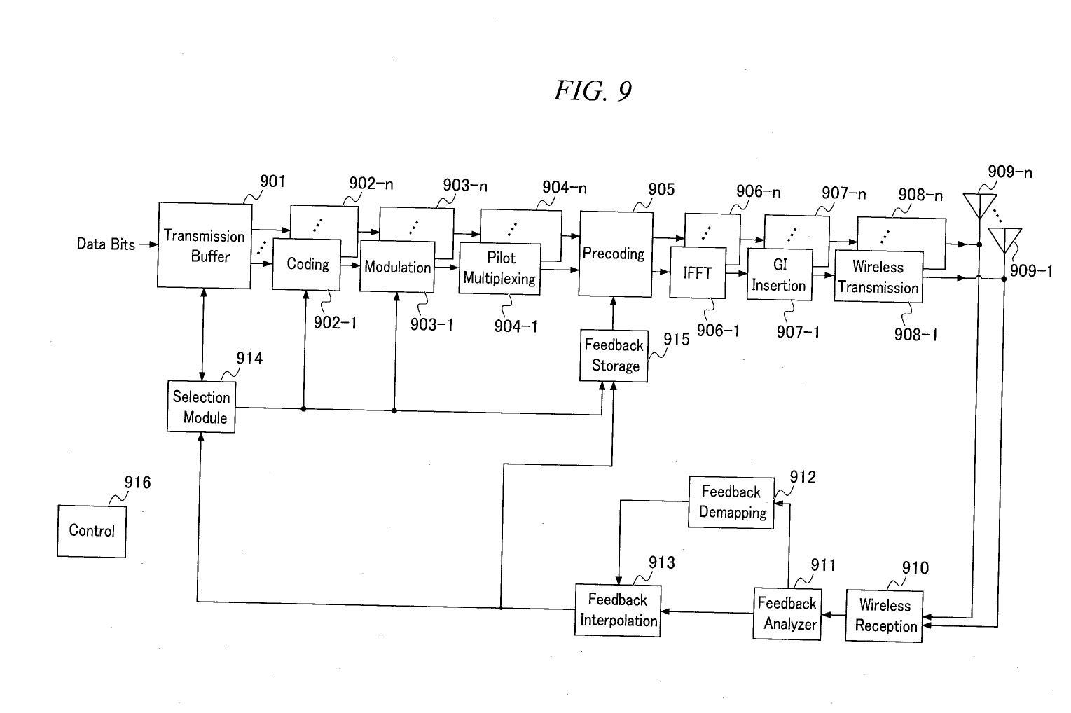

FIG. 11 is a flowchart showing the procedure of a central value interpolation performed in Feedback Interpolation module 913 depicted in FIG. 9.

An access point is configured to receive the channel values in representative frequency points selected among all of the frequency points in the bandwidth as feedback. The term “frequency point” indicates the central frequency of OFDM subcarrier. The term “frequency point” may be abbreviated as “point”.

In the central value interpolation, a representative frequency point corresponds to a fixed set of points. The set is made by two, four or eight consecutive points, for example. The access point first identifies which representative points correspond to the received channel values respectively (1101), and assigns the values to all of the missing points of the identified sets respectively (1102).

For the central value interpolation, a station may send the exact channel value in a representative point or the average channel value with respect to the points belonging to the set, for example. The latter operation eliminates spikes of noise and results in better performance.

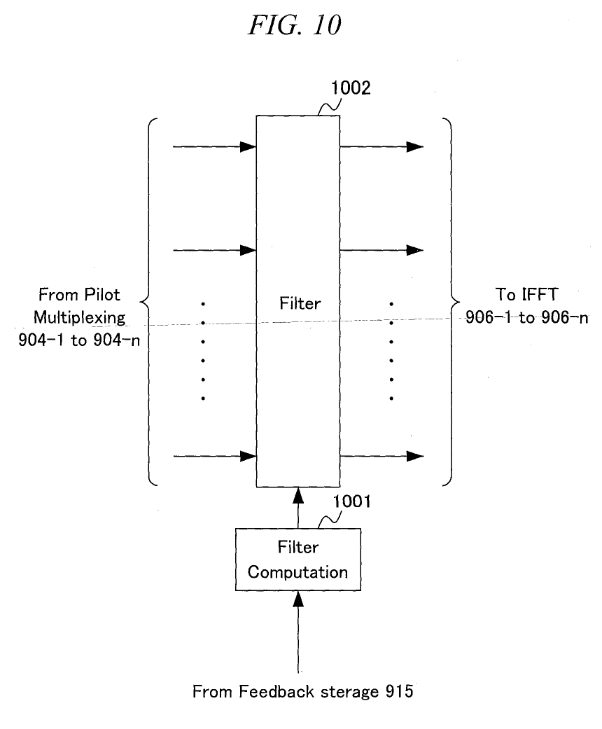

FIG. 12 is a flowchart showing the procedure of a linear interpolation.

In the linear interpolation, a representative frequency point corresponds to a fixed set of points.

An access point first identifies which representative points correspond to the received channel values respectively (1201). The access point finds line segments joining each pair of the channel values in consecutive representative points (1202), and assigns the line segment values in missing points to the points respectively (1203).

The linear interpolation is a very simple interpolation method, with very low computational load as in the central value interpolation, and in addition, its application results in a clear improvement over the central value interpolation.

A sinc interpolation will be explained next. The sinc interpolation uses a sine cardinal or sinc function like sinc (x)=sin (x)/x. The sinc interpolation accommodates the representative frequency points to a series of sinc functions as seen in the following equation.

$$\begin{matrix}( Equation 1 ) & \\ x ( k ) = {\sum }_{n = - ∞}^{∞} x [ n ] \cdot sin c ( \frac{k - n \cdot T}{T} ) = {\sum }_{n = - L}^{L} x [ n ] \cdot sin c ( \frac{k - n \cdot T}{T} ) & ( 1 )\end{matrix}$$

In Equation (1), x(k) is the interpolated value in the missing point k, [−L, L] is the range of the subcarriers in the given bandwidth, T is the sampling period which corresponds to the bandwidth of a subcarrier and x[n] is the channel value in the representative point n.

The procedure of sinc interpolation method is easy because it is not necessary to find slopes like a cubic interpolation, but the computational load becomes heavier compared to that of a central value or linear interpolation.

The sinc interpolation method is affected by the Gibbs phenomenon, causing ringing that can be very severe. Therefore, an appropriate window, such as Hamming window, Kaiser window, Blackman window, etc. can be used together with sinc interpolation method to eliminate such ringing.

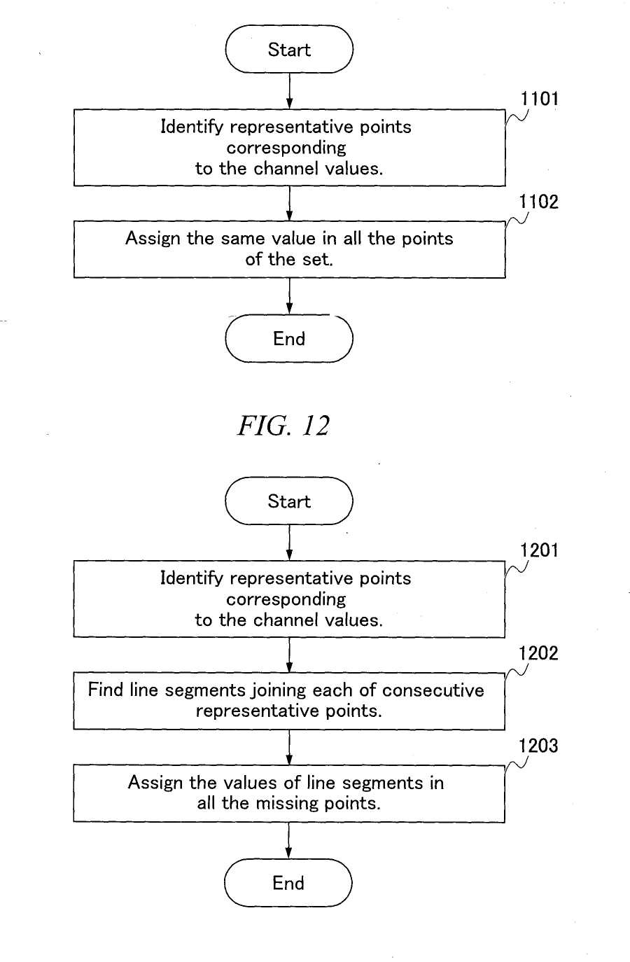

FIG. 13 is a flowchart showing the procedure of a cubic interpolation.

An access point first identifies which representative points correspond to the received channel values respectively (1301). Then, the access point finds slopes of the channel characteristics in the representative points respectively (1302). With the received channel values and calculated slopes, the access point finds the channel values in missing points (1303).

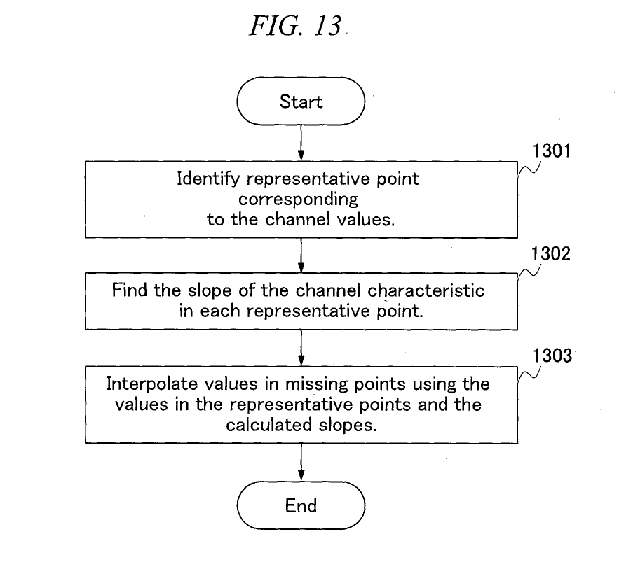

FIG. 14 is a flowchart showing the step 1302 in greater detail. It is preferable especially for a pchip interpolation.

An access point determines whether a representative point is an interior or end point (1401). If it is an interior point, here let it be named “point B”, the access point finds line segments AB and BC which join the values in the point B and neighboring representative points A and C at both sides, respectively, and calculates slopes S_{AB} and S_{BC} of the line segments (1402).

The access point compares signs of S_{AB} and S_{BC}, and determines whether the signs are equal or neither is zero substantially (1403). If the judgment in step 1403 proved true, the access point finds the slope S_{B} in point B as shown in the following equation (1404).

$$\begin{matrix}( Equation 2 ) & \\ \frac{1}{{S}_{B}} = \frac{1}{{w}_{AB} + {w}_{BC}} \cdot ( \frac{{w}_{AB}}{{S}_{AB}} + \frac{{w}_{BC}}{{S}_{BC}} ) \\ {w}_{AB} = 2 \cdot {d}_{AB} + {d}_{BC} \\ {w}_{BC} = {d}_{AB} + 2 \cdot {d}_{BC} & ( 2 )\end{matrix}$$

If the judgment in step 1403 proved false, the access point finds that slope S_{B} is zero (1405).

Turning back to the first step 1401, if the representative point is an end point, here let it be named “point A”, the access point finds line segments AB and BC which join consecutively the values in point A and neighboring representative points B and C at one side, respectively, and calculates the slopes S_{AB} and S_{BC} of the line segments. And, the access point calculates the tentative slope S_{A,T}, as shown in the following equation.

$$\begin{matrix}( Equation 3 ) & \\ {S}_{A , T} = \frac{{w}_{AB} \cdot {S}_{AB} + {w}_{BC} \cdot {S}_{BC}}{{d}_{AB} + {d}_{BC}} \\ {w}_{AB} = 2 \cdot {d}_{AB} + {d}_{BC} \\ {w}_{BC} = - {d}_{AB} & ( 3 )\end{matrix}$$

The access point is configured to compare the signs of S_{A,T} and S_{BC}, and determine whether the signs are equal or neither is zero substantially (1413). If the judgment in step 1413 proved false, the access point finds the slope S_{A} is zero (1414). If the judgment proved true, the access point compares the signs of S_{AB} and S_{BC}, and determines whether the signs are equal (1415). If the judgment proved true, the access point finds the slope S_{A} is equal to S_{A,T} (1418).

If the judgment proved false, the access point determines whether the absolute value of S_{AB} multiplied by number 3 is larger than the absolute value of S_{A,T} (1416). If the judgment proved true, the access point finds the slope S_{A} is equal to S_{AB} multiplied by three (1417). If the judgment proved false, the access point finds the slope S_{A} is equal to S_{A,T} (1418).

The above procedure is repeated for all of interior and end points.

In the following, another way of carrying out the step 1302 in FIG. 13 will be explained. It is preferable for cubic interpolation, especially for cubic spline interpolation.

The slopes of representative points are calculated by solving the following simultaneous equations.

$$\begin{matrix}( Equation 4 ) & \\ ( \begin{matrix}{h}_{2} & 2 \cdot ( {h}_{1} + {h}_{2} ) & {h}_{1} & & & & & \\ & {h}_{3} & 2 \cdot ( {h}_{2} + {h}_{3} ) & {h}_{2} & & & & \\ & & ⋱ & & ⋱ & & ⋱ & \\ & & & & & {h}_{n - 1} & 2 \cdot ( {h}_{n - 2} + {h}_{n - 1} ) & {h}_{n - 2}\end{matrix} ) \cdot ( \begin{matrix}{d}_{1} \\ {d}_{2} \\ ⋮ \\ {d}_{n}\end{matrix} ) = 3 \cdot ( \begin{matrix}{h}_{2} \cdot {δ}_{1} + {h}_{1} \cdot {δ}_{2} \\ {h}_{3} \cdot {δ}_{2} + {h}_{2} \cdot {δ}_{3} \\ ⋮ \\ {h}_{n - 1} \cdot {δ}_{n - 2} + {h}_{n - 2} \cdot {δ}_{n - 1}\end{matrix} ) & ( 4 )\end{matrix}$$

In the above equation, dₖ is the slope in a representative point xₖ, hₖ is the distance between points xₖ and xₖ₊₁ and the letter “delta” of Greek alphabet with suffix k is the slope of a line segment which joins the values in points xₖ and xₖ₊₁.

In Equation 4, it is assumed that the first and second derivatives of the channel function at point xₖ are continuous. Besides that, a new point x₀ is created outside of end point, and the following equation is assumed. The letter “delta” of Greek alphabet with suffix 0 is the corresponding slope.

(Equation 5)

h₀=h₁

δ₀=δ₁ (5)

According to the interpolation method using Equation 4 and 5, the overshoot of a cubic spline is avoided. Such a cubic spline is a natural spline.

Now, the details of the step 1303 shown in FIG. 13 will be explained.

The values of missing points are acquired by the following equation.

$$\begin{matrix}( Equation 6 ) & \\ P ( x ) = \frac{3 \cdot h \cdot {s}^{2} - 2 \cdot {s}^{3}}{{h}^{3}} \cdot {y}_{k + 1} + \frac{{h}^{3} - 3 \cdot h \cdot {s}^{2} + 2 \cdot {s}^{3}}{{h}^{3}} \cdot {y}_{k} + \frac{{s}^{2} \cdot ( s - h )}{{h}^{2}} \cdot {d}_{k + 1} + \frac{s \cdot {( s - h )}^{2}}{{h}^{2}} \cdot {d}_{k} \\ P ( {x}_{k} ) = {y}_{k} ; P ( {x}_{k + 1} ) = {y}_{k + 1} \\ {P}^{′} ( {x}_{k} ) = {d}_{k} ; {P}^{′} ( {x}_{k + 1} ) = {d}_{k + 1} \\ {x}_{k} \leq x \leq {x}_{k + 1} \\ h = {x}_{k + 1} - {x}_{k} \\ s = x - {x}_{k} & ( 6 )\end{matrix}$$

In Equation (6), P(x) is the interpolated value in points x (xₖ≦x≦xₖ₊₁), xₖ is a representative point, yₖ is the channel value in point xₖ, dₖ is the slope in point xₖ, h is the distance of the k^{th} subinterval (h=xₖ₊₁−xₖ), and s is the distance between the interpolated point x and the representative point xₖ.

The cubic interpolation method achieves higher resemblance to the real channel, because it considers not only the values of representative points, but also the slopes respectively.

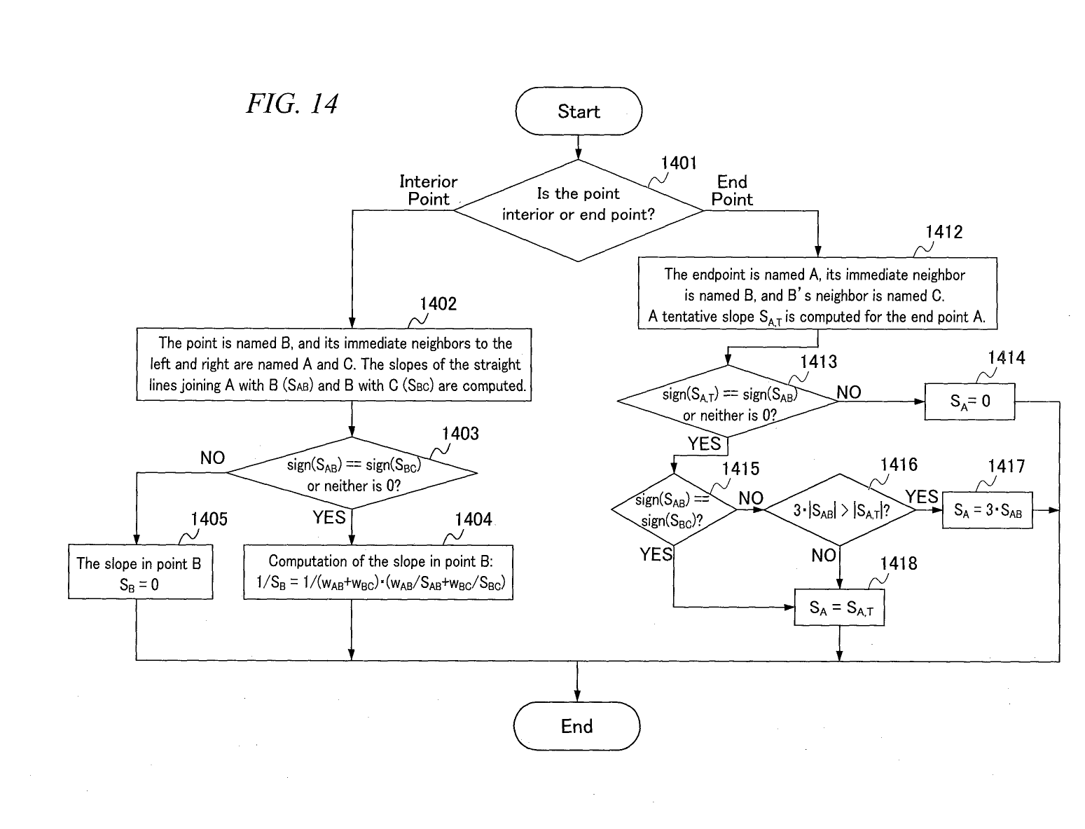

FIG. 15 is a schematic block diagram of a station according to the first preferred embodiment.

Wireless Reception module 1502 receives wireless signals through antenna 1501, converts them to baseband signals, performs DA conversion and transfers the digital signals to GI Extraction module 1503. GI Extraction module 1503 extracts GI from the digital signals and transfers the remainder to FFT module 1504 to perform Fast Fourier Transform to obtain frequency domain signals. The result of FFT is sent to Pilot Demultiplexing module 1505.

Pilot Demultiplexing module 1505 extracts pilot signals (channel estimation signals) from the remainder. The remainder is transferred to Channel Compensation module 1506 and the pilot signals are sent to Channel Estimation module 1509. Channel Estimation module 1509, based on the values of the extracted pilot symbols, estimates the channels between Antenna 1501 and transmit antennas of the access point.

Channel Compensation module 1506 is configured to perform channel compensation to the received signals from Pilot Demultiplexing module 1505 based on the information from Channel Estimation module 1509. Demodulation module 1507 is configured to demodulate the signals output from Channel Compensation module 1506. Decoding module 1508 is configured to decode the signals output from Demodulation module 1507 and retrieve data bits.

Optimal Selection module 1510 is configured to perform the operation of finding representative frequency points based on the channel information sent from Channel Estimation module 1509. Optimal Selection module 1510 is configured to send the channel values in representative points and the quantization level to Feedback Creation module 1511 and sends the positions of representative points to Incremental Mapping module 1511.

Incremental Mapping module 1511 finds an incremental mapping and number of representative points, and sends them to Feedback Creation module 1512.

Feedback Creation module 1512 puts the channel values in representative points and the quantization level to VHT beamforming Report 636 in FIG. 6A and Quantization 647 in FIG. 6B respectively, and puts the incremental mapping and number of representative points to Mapping 635 and Number of Subcarriers 634 in FIG. 6A, respectively. Other fields of SND FB in FIG. 2 are sent from the upper layer to the Feedback Creation module 1512, but the detailed explanation of it will be omitted because of it belonging to well-known matters.

Wireless Transmission module 1513 is configured to perform DA conversion to the signals of FBPoll transferred from Feedback Creation module 1512, convert them to a wireless frequency band and transmit them to the access point through Antenna 1501. Control module 1514 performs the necessary actions for the above mentioned modules.

Next, the selection of representative frequency points at a station will be explained.

The selection is performed by preferably selecting every second point to obtain representative points.

Alternatively, it is preferably performed by selecting every fourth point to obtain representative points.

Alternatively, it is preferably performed by selecting every eighth point to obtain representative points.

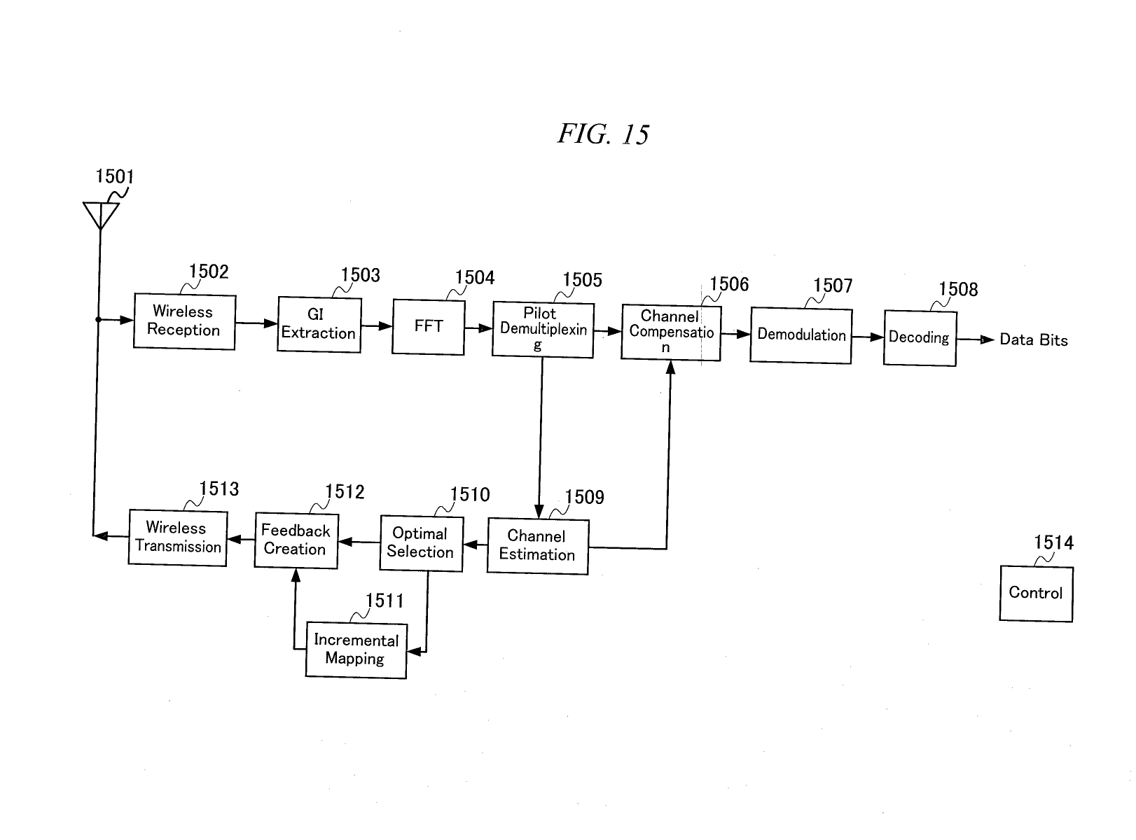

A fourth preferred selecting method will be explained referencing to the flowchart in FIG. 16.

In FIG. 16, a station is configured to take the real parts of each element of the channel matrices in all of the frequency points sequentially (1601). The station is configured to find a differentiable channel function, based on the real parts, then finds the points that present a relative maximum or minimum, and incorporates them to a set K as its elements (1602). It preferably incorporates also the first and last points to the set K (1603). Then, it preferably separates one of the neighboring points in K except endpoints that are closer than a defined distance dₖ, and incorporates the remainder to a set Kₛ as its elements (1604).

If it is necessary, the station will perform the following steps 1605 and 1606. It finds points K₊, at the values of which the tangents are parallel or substantially parallel to the line segments joining the values of neighboring points in the set Kₛ respectively (1605). Then, it separates one of the neighboring points K₊ that are closer than a defined distance dₖ₊, and incorporates the remainder into a set Kₑₓₜᵣₐ as its elements (1606). The points of sets Kₛ and Kₑₓₜᵣₐ are chosen for feedback (1607). The steps 1602 to 1607 are repeated for the real parts of each element of the channel matrices at all of the frequency points.

Then, the station decides whether the above steps have already been iterated for the imaginary parts (1608). If the above steps are not iterated for the imaginary parts, the station takes the imaginary parts sequentially (1609). The station processes the step 1602. If the imaginary parts have already been processed, the station creates information to let the access point know which points were selected (1610).

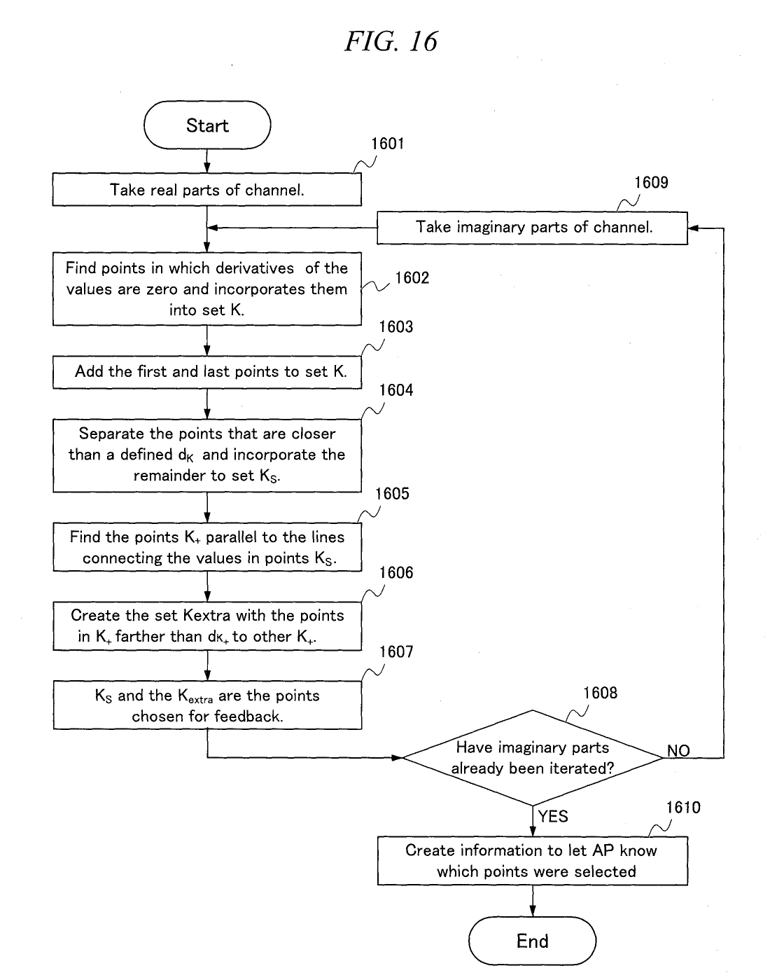

FIG. 17 is a graph explaining the procedure of FIG. 16. In FIG. 16, the transverse axis shows frequency and the vertical axis shows channel value.

Curve 1701 shows the channel function. Black dots 1711 and 1712 denote the values of the points which are found in the step 1602 shown in FIG. 16. Line 1721 shows a line segment joining black dots 1711 and 1712. White dots 1731 to 1733 denote the values of the points which are found in the step 1605. Tangents of the curve 1701 at the white dots 1731 to 1733 are parallel or substantially parallel to the line segment 1721.

In a fifth preferred Selecting Method, the procedure of steps 1602 and 1605 shown in FIG. 16 can be modified by using line segments joining the values of neighboring points instead of using the channel function, and by following the same way as shown in the flowchart in FIG. 14.

In a sixth preferred Selecting Method, steps 1604 to 1606 shown in FIG. 16 are omitted. It is substantially matched to the cubic spline interpolation rather than the pchip interpolation.

In the fourth through sixth Selection Methods, the representative frequency points (subcarriers) are selected irregularly from the subcarriers defining the frequency band used in the wireless communication.

Next, feeding back of the representative points will be explained.

The frequency positions of representative points can be fed back as they are. However, an incremental mapping is more efficient.

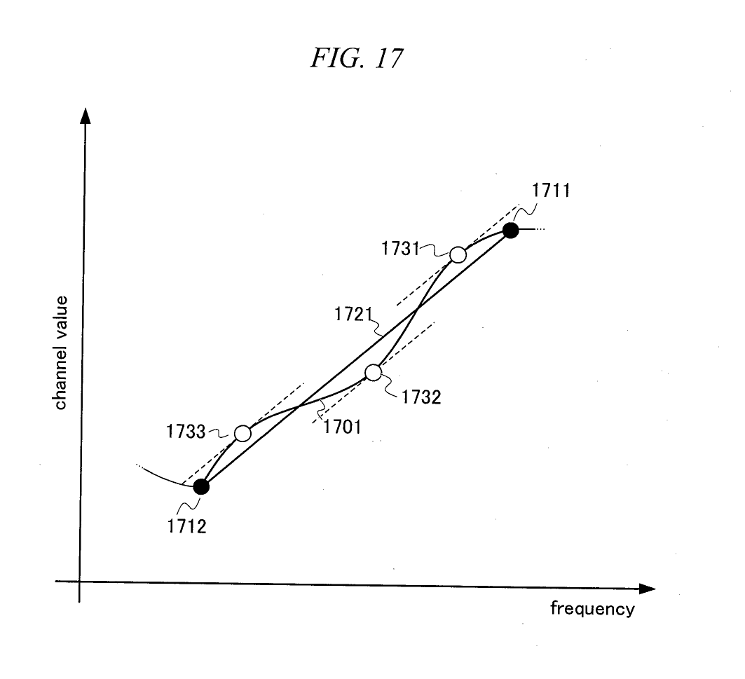

FIG. 18 is a flowchart showing the procedure, in which the Incremental mapping is calculated.

The first and last frequency points that are fed back are the first and the last ones of the subcarriers, and thus no mapping is needed for them. The first value of the incremental mapping is the distance between the first and second representative points. The second value of the incremental mapping is the distance between the second and third representative points. This procedure continues until the penultimate representative point.

The station is configured to set the minimum distance dₘᵢₙ between consecutive representative points (1801). The distance dₘᵢₙ is the minimum between the distance d_{K} as defined in the method 1604 and the distance ‘d_{K+}’ as defined in the method 1606 of FIG. 16. Then, it sets the maximum distance dₘₐₓ (1802). For example, dₘₐₓ may be the sum of two to the power of five and dₘᵢₙ. It calculates the distance d of consecutive representative points respectively (1803), and finds the reduced number d+ that is the subtraction of dₘᵢₙ from d (1804).

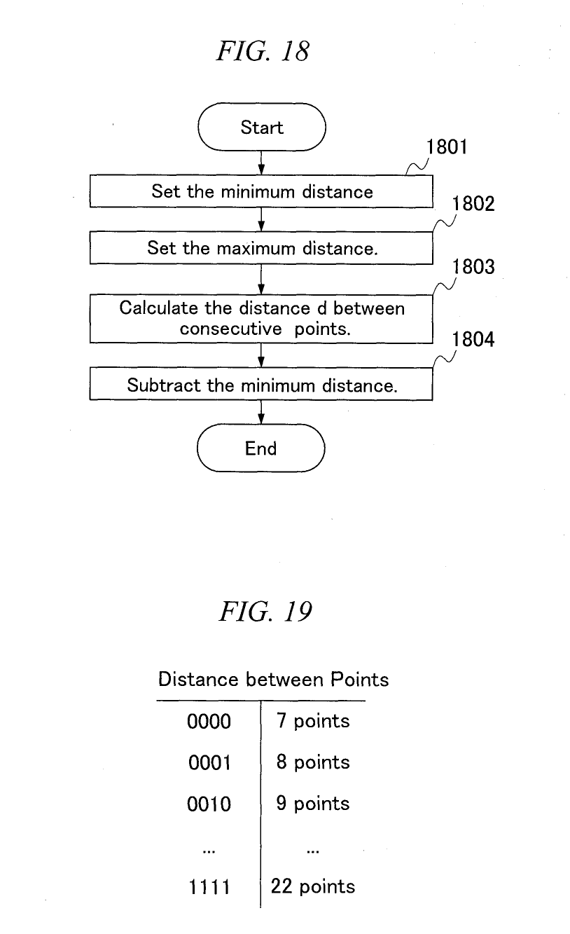

FIG. 19 shows an exemplary coding using the incremental mapping.

In FIG. 19, ‘0000’ indicates 7 points of distance, and ‘1111’ indicates 22 points of distance. In this example, the distance dₘᵢₙ is preferably set to 7 points, therefore the distance between consecutive representative points conveyed by a predetermined number of bits will be increased.

Alternatively, the distance between mapped values could be only multiple of 2 (even), e.g. ‘000’ indicates the distance between consecutive representative points is 2 points, ‘001’ indicates the distance between consecutive representative points is 4 points, ‘010’ indicates the distance between consecutive representative points is 6 points. In this way, the incremental mapping will be simplified.

Lesser header of the feedback frame and optimum reconstruction of channel characteristics at the access point using the specified interpolation method can be achieved by the appropriate representative points and/or quantization level of channel values found by the station. To this end, the number of selected frequency points and/or quantization level preferably is small and the deviation of interpolated channel matrices from the real channel matrices preferably is also small.

The deviation of interpolated channel matrix from the channel matrix is shown in the following Equation 9, where H is the real channel matrix as perceived by the station, H_{interpolated} is the interpolated channel matrix resulting from the values to be sent as feedback, “i” is the row index of the matrix (from 1 to N_{T}); “j” the column index of the matrix (from 1 to N_{R}) and “n” the subcarrier index of the matrix (from 1 to N_{SC}).

$$\begin{matrix}( Equation 7 ) & \\ {ɛ}_{i , j}^{2} = {\sum }_{n = 1}^{{N}_{SC}} {\sum }_{i = 1}^{{N}_{T}} {\sum }_{j = 1}^{{N}_{R}} {\vert {H}_{interpolated} ( i , j , n ) - H ( i , j , n ) \vert}^{2} & ( 7 )\end{matrix}$$

Generally, if the pchip or cubic spline interpolation method is designated by the access point, then the station may adopt one of the aforementioned Selecting Methods 4 to 6 and small number of quantization level. On the contrary, if central value, linear or sinc interpolation method is designated, the station may adopt one of the aforementioned Selecting Methods 1 to 3 and high number of quantization level.

According to the first preferred embodiment of the present invention, it is possible that an access point designates the preferable interpolation method, and a station sends back an optimized channel state information.

The format of a beacon according to the second preferred embodiment of the present invention is preferably the same to the first preferred embodiment except for the Supported Interpolation 331 in FIG. 3B.

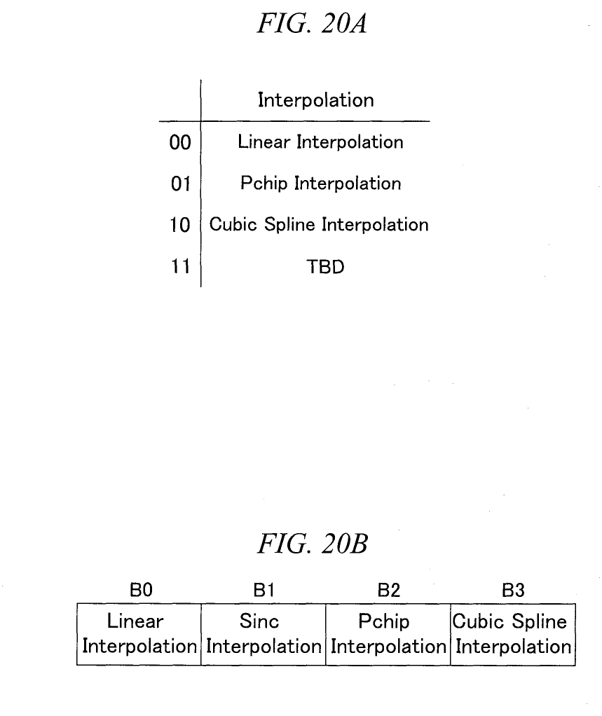

FIG. 20A shows the details of Supported Interpolation field according to the second preferred embodiment. The field preferably includes two bits, for example, and shows the highest level interpolation method. The highest level interpolation method preferably is the one which consumes the largest power, and shows the highest precision when the number of representative points is small. If an access point can perform up to a linear interpolation, the field is set to ‘00’. If the access point can perform up to a pchip interpolation, the field is set to ‘01’. If the access point can perform up to a cubic spline interpolation, the field is set to ‘10’. The value ‘11’ is reserved for future use in this example, although it may be assigned to a different interpolation method.

Generally, an increase in the accuracy of the results of an interpolation comes at the cost of a higher computational load. It is unlikely that an access point is able to perform one high computational load method such as the cubic spline interpolation and not a relatively simpler one such as the linear interpolation. Therefore, it is not needed to reserve a bit to indicate the ability of performing each interpolation method. The access point can indicate the highest computational load interpolation method which it supports, and the station is able to implicitly understand that the access point can support lower computational load interpolation method.

FIG. 20B is another example. In this case, the field preferably includes four bits, for example. If the bit B0 of the field is set to ‘1’, the access point supports a linear interpolation method. If B1 is set to ‘1’, the access point supports sinc interpolation method. If B2 is set to ‘1’, the access point supports a pchip interpolation method. If B3 is set to ‘1’, the access point supports a cubic spline interpolation method. If any one of B0 to B3 is set to ‘1’, the access point support all of the corresponding interpolation method.

In this case, the station is able to explicitly understand which interpolation methods are supported at the access points.

On a certain occasion, the workload required to calculate the optimum representative frequency points for the best performing interpolation method is beyond reach of the station's computing capabilities, either for lack of raw computational power or for some other simultaneous tasks requesting processor time. Sometimes, the station may prefer to use a lower computational calculation to save battery and so on. Therefore, in that case, the station adopts a low level interpolation method such as a central value interpolation method. Otherwise, it adopts a high level interpolation method which the access point permits.

The selection of representative frequency points and quantization levels may be performed as that of the first preferred embodiment.

Also, the station may choose one interpolation method among the ones which the access point indicates, depending on the state of channel conditions. The station may evaluate (measure) the channel simply from the amount of relative maximums and minimums channel values in the transmission bandwidth. A high number of the relative maximums and minimums imply hard channel, therefore the interpolation method and representative points which level is high are selected. A small number of the relative maximums and minimums imply mild channel, therefore the interpolation method and representative points which level is low are selected. The station may also calculate slopes connecting the channel values in consecutive frequency points respectively, and find the average of the absolute values. A high average imply hard channel, while a low average is an imply mild channel. The station may also consider the incidence of a slope steeper than a predetermined value. More slopes over this value reflect a harder channel.

When the channel is hard, the station may send back a lot of representative points and quantization level, while the channel is mild, it may send back a small number of those things. Speaking to the selecting method, in the former case, either one of Selecting Methods 1 to 3 may be chosen, while in the latter case, either one of Selecting Methods 4 to 6 may be chosen.

The format of SND FB frame according to the second preferred embodiment is preferably the same to the first preferred embodiment except for VHT MIMO Control 633 in FIG. 6A.

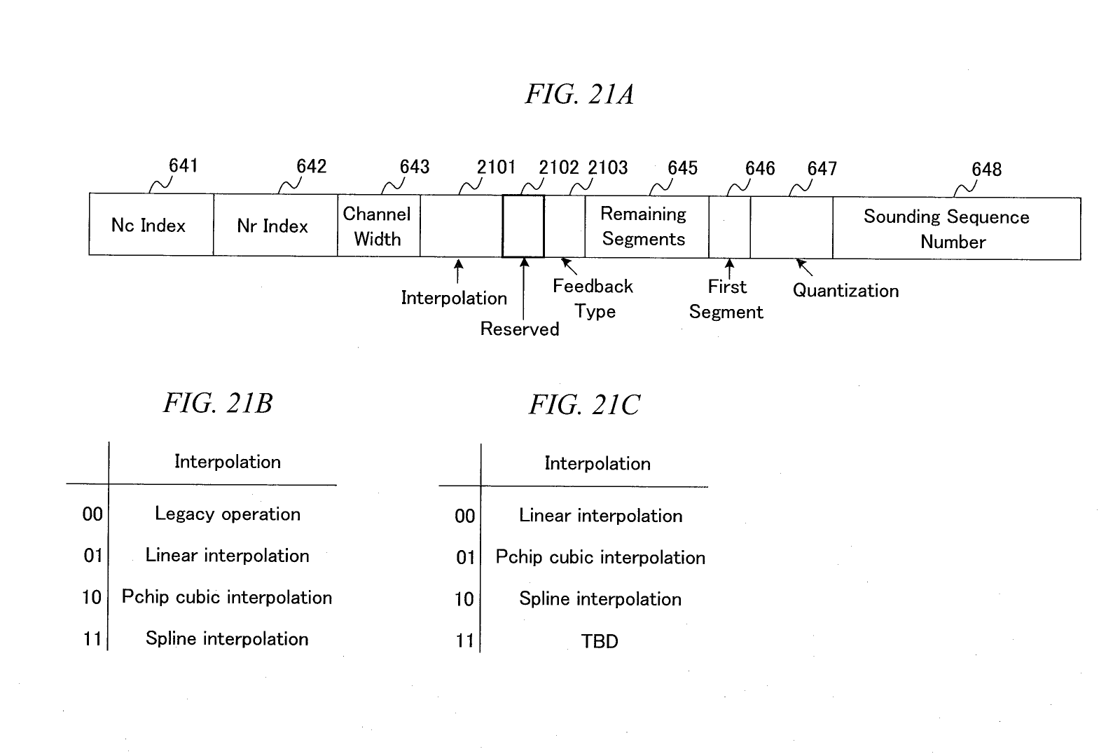

FIG. 21A shows the details of VHT MIMO Control 633a according to the second preferred embodiment of the present invention. Reserved 644 in FIG. 6B according to the first preferred embodiment is changed to Interpolation 2101, Reserved 2102 and Feedback Type 2103, but other fields in FIG. 21A are preferably kept the same to those of FIG. 6B.

FIG. 21B shows an exemplary configuration of Interpolation 2101. The station sets the field to ‘00’ if the feedback is not optimized according to any interpolation methods according to the preferred embodiments of the present invention (legacy operation). It sets the field to ‘01’, if the feedback is a linear interpolation. It sets the field to ‘10’, if the feedback is optimized for a pchip interpolation. It sets the field to ‘11’, if the feedback is a cubic spline interpolation.

FIG. 21C shows another possible configuration in which the legacy operation is not considered.

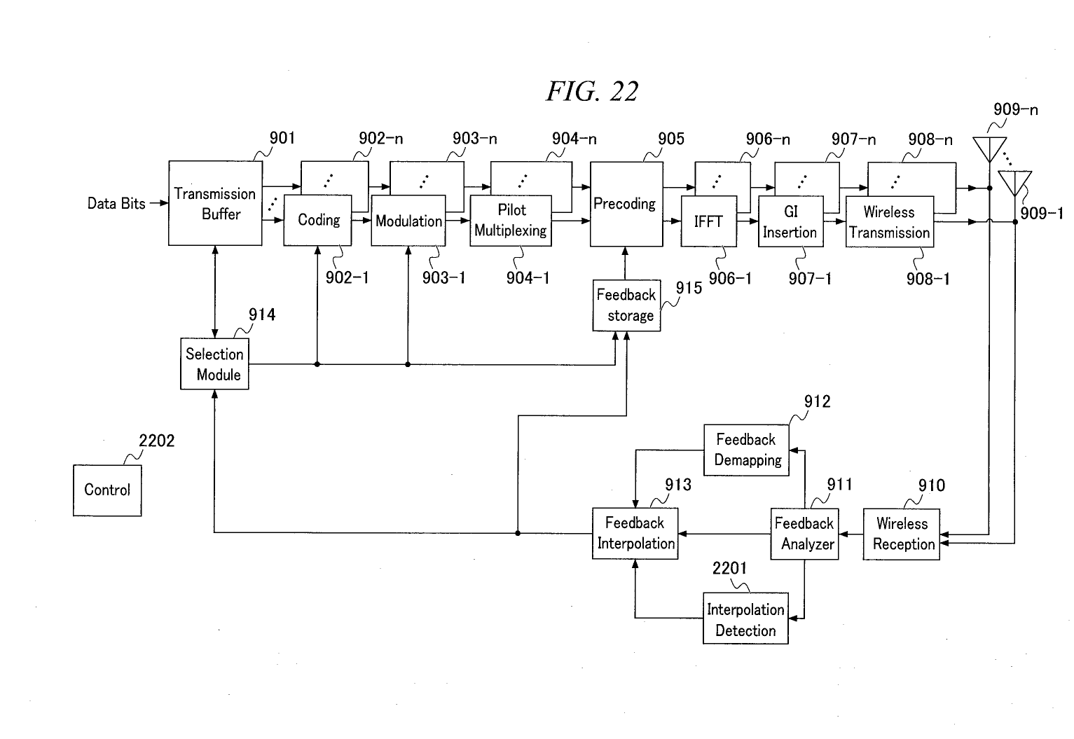

FIG. 22 is a schematic block diagram of an access point according to the second preferred embodiment. Compared to FIG. 9 according to the first preferred embodiment, only Interpolation Detection module 2201 is added to in FIG. 22 and other modules are kept the same as those of the first preferred embodiment.

Interpolation Detection module 2201, configured to receive the interpolation field contents from Feedback Analyzer 910, detects the interpolation method for which the feedback is optimized for, and provides notice of this method to Feedback Interpolation module 913.

Control module 2202 indicates the several interpolation methods selected out of a plurality of interpolation methods.

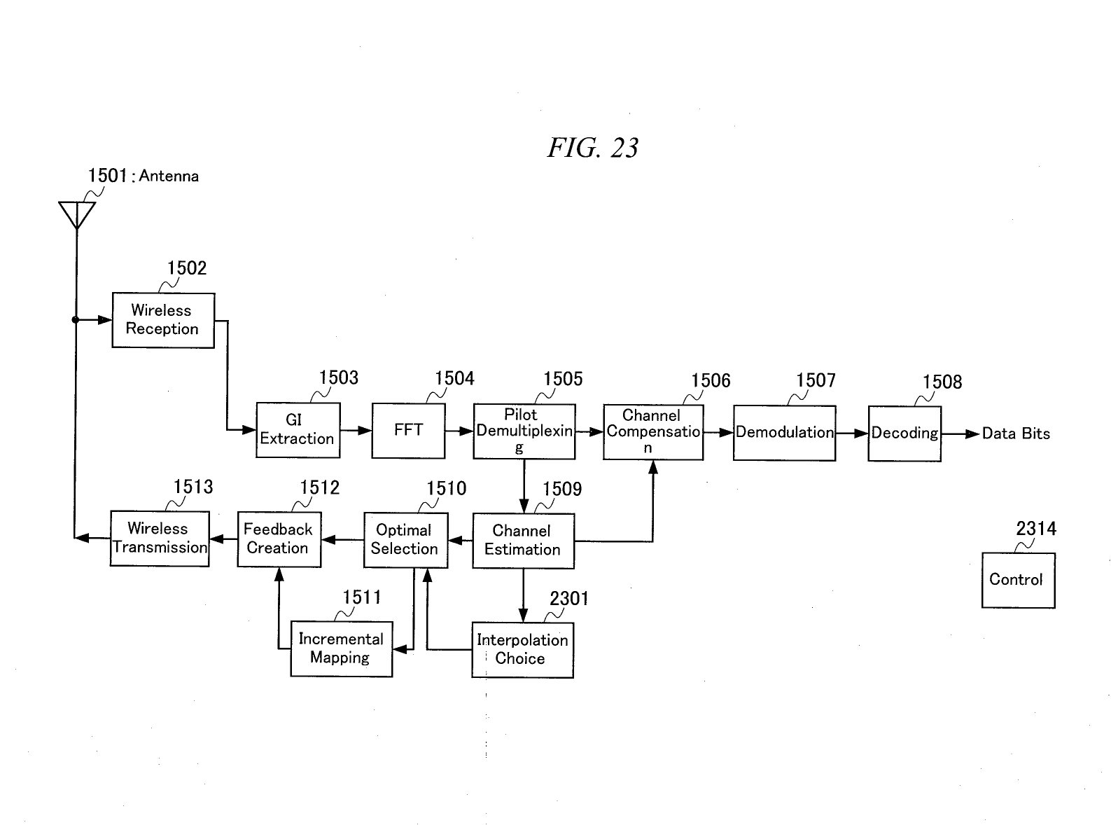

FIG. 23 is a schematic block diagram of a station according to the second preferred embodiment. Compared to FIG. 15 according to the first preferred embodiment, only Interpolation Choice module 2301 is added and Control module 1514 (FIG. 15) is changed to Control module 2314 in FIG. 23, however other modules are kept the same.

Interpolation Choice module 2301, configured to receive the channel matrices from Channel Estimation module 1509 and the additional information from Control module 2314, decides which interpolation method is to be used to optimize the feedback for and informs it to Optimal Selection module 1510.

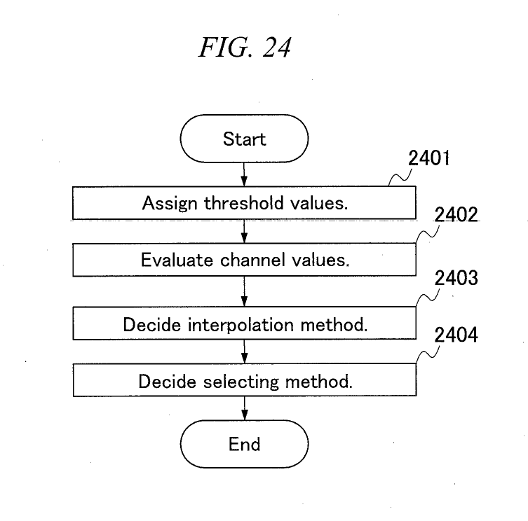

FIG. 24 is a flowchart showing the procedure to choose an interpolation method and then to select representative points at the station.

The station assigns threshold values for its particular measurement methods (2401). These threshold values may be the predetermined values that are always the same regardless of the conditions of the station, or alternatively the station could vary them depending on its conditions. For instance, the station could raise the threshold value for computationally heavy interpolation methods when the station's battery charge level is low, or it could regulate the threshold values according to the idleness of the station's CPU.

The station evaluates channel values (2402). The station then decides which interpolation method to use (2403). The station then decides which selecting method to use to find representative frequency points just like the first preferred embodiment (2404).

According to the second preferred embodiment, a station is able to select the most appropriate interpolation method and then to select representative frequency points, considering its particular conditions.

In the third preferred embodiment of the present invention, an access point preferably sends some more information aiding a station to choose the most suitable parameters.

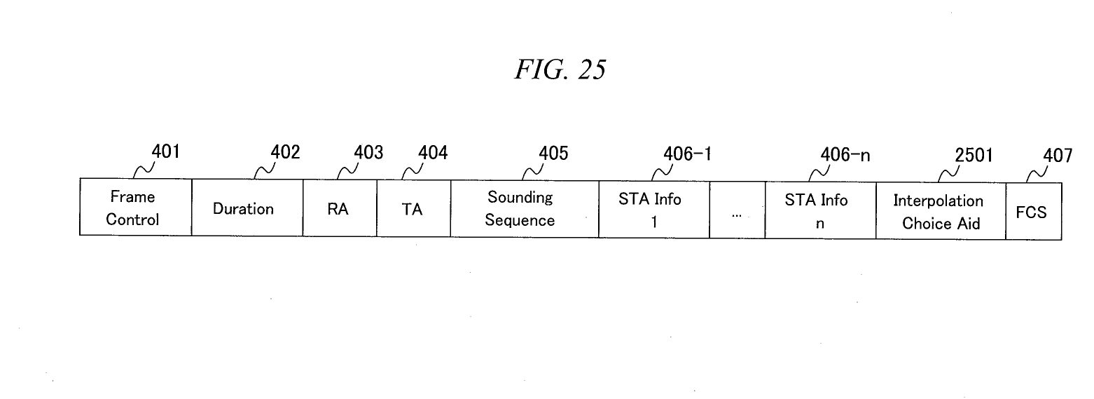

FIG. 25 shows an NDPA field of the third preferred embodiment. Compared to the NDPA field of the first preferred embodiment (FIG. 4a), it has Interpolation Choice Aid 2501 as an extra field. FB Poll according to the third preferred embodiment preferably is configured to also furnish such Interpolation Choice Aid.

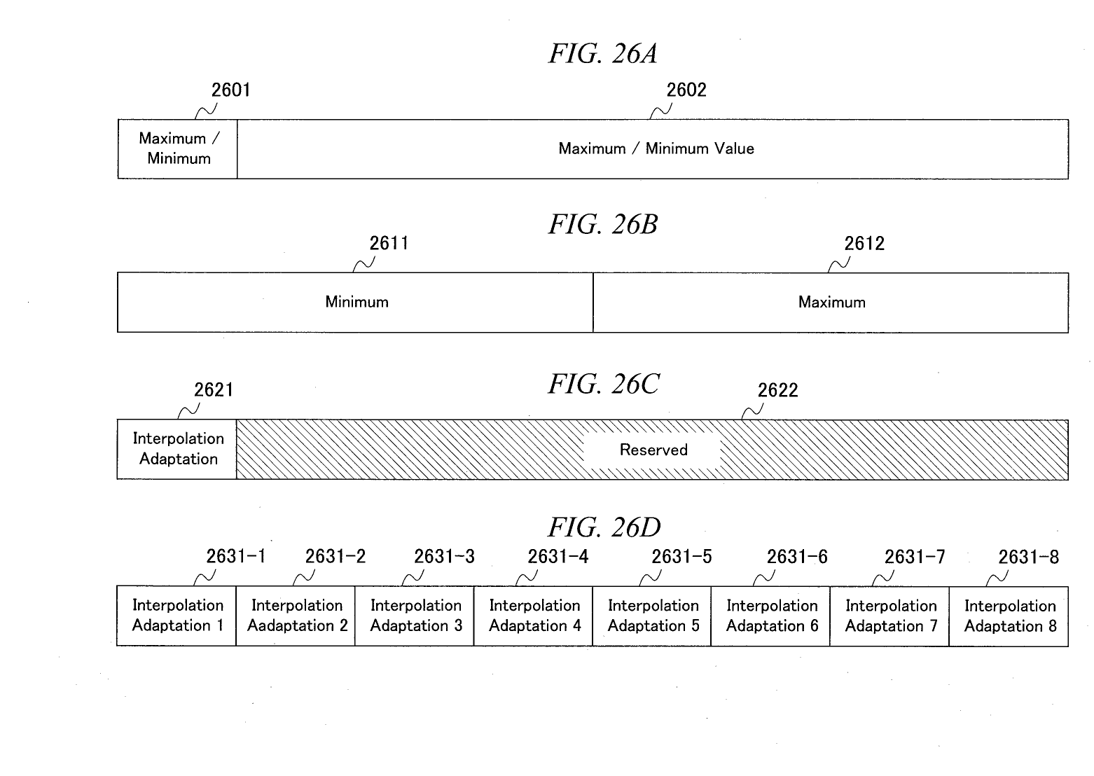

FIG. 26A shows the details of Interpolation Choice Aid 2501.

FIG. 26A shows an example in which an access point sets the minimum or maximum number of representative frequency points which a station can transmit. In this example, two fields are preferably used. Maximum/Minimum 2621 is set to ‘1’, when the constraint is referred to the maximum amount of subcarriers to be sent. It is set to ‘0’, when it is referred to the minimum amount of subcarriers to be sent. Maximum/Minimum value 2602 is a 7 bit representation of the value decided by the access point. For example, the access point can decide to limit the feedback to no more than a given number of frequency points (Maximum/Minimum 2611 set to ‘maximum’). Alternatively, the access point preferably decides to have a given number of frequency points exceeding some minimum setting. For doing this, the access point sends the indication of a minimum number of frequency points to be used for feedback (Maximum/Minimum 3721 set to minimum).

Alternatively, FIG. 26B shows an example in which the access point indicates both the minimum and the maximum amount of representative frequency points to be used for feedback. Minimum 2611 preferably contains the minimum value of points to be used. Maximum 2612 preferably contains the value of the maximum number of points to be used. In both cases, the value could be extended by transmitting only even values, in which case ‘00’=2, ‘01’ =4, etc. or by using tables previously defined. Furthermore, it is unlikely that maximum 2612 is set to low values such as 2 or 4 subcarriers. A predefined offset can be applied to it to further extend the range.

In another example, the access point is configured to tell each station which maximum MSE must be obtained. Interpolation Choice Aid 2501 gives the first station to transmit its feedback the maximum value of MSE. The station knows both the channel matrices and the interpolation method of the feedback it's sending to the access point. With both values, the station can calculate the MSE and adjust the feedback as needed.

Next, the variation will be explained. An access point can decide if the quality must be increased or reduced by observing the packet error rate which the link with a given station is incurring. If the packet error rate is too high, the access point could decide to increase the quality of the feedback to avoid retransmissions at the cost of a potentially higher overhead. If the packet error rate is very good, the access point could decide to reduce the quality of the feedback. The phrase “quality of feedback” indicates the total number of representative points and quantization level.

In a network with one or very few stations, an access point could decide to increase the quality of the feedback to acquire a better knowledge of the channel and minimize the interferences between stations. On the contrary, in a scenario in which many stations are present, reducing the quality of the feedback could have a beneficial effect in the overall throughput.

FIG. 26C shows another example of Interpolation Choice Aid 2501.

Interpolation Choice Aid 2501 includes Interpolation Adaptation 2601 of one bit and Reserved 2602 of seven bits, for example.

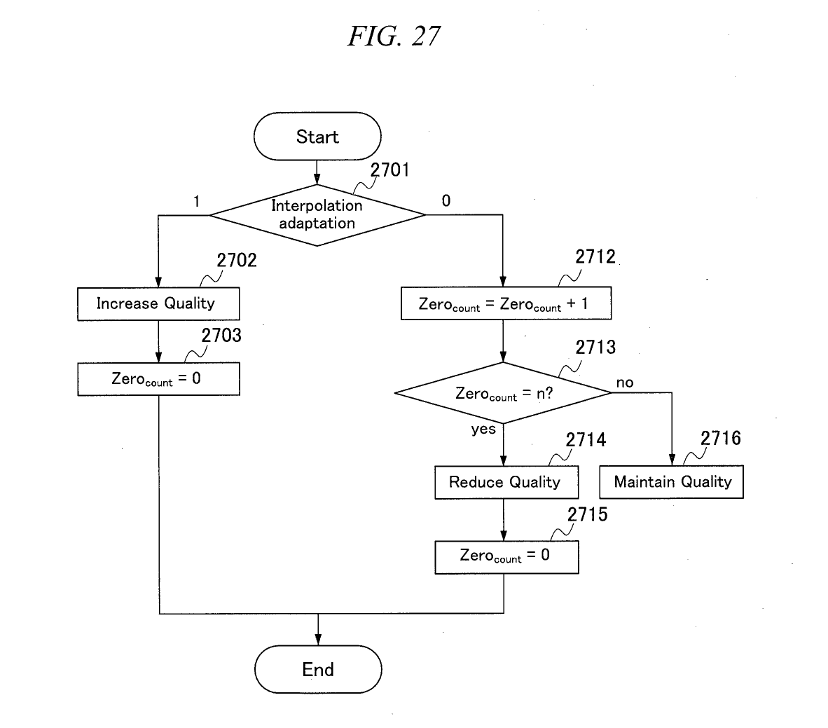

FIG. 27 shows a flowchart explaining the actions of a station receiving such field of Interpolation Adaptation 2621 in FIG. 26C.

A station has a counter “zero_{count}” in the Controller. The station keeps Zero_{count} which is set to 0 when the station first establishes the connection with the access point. The station checks the value of Interpolation adaptation 2621 (2701). If its value is ‘1’, the station increases the quality of feedback (2702) and Zero_{count} remains zero (2703).

Turning back to step 2701, the station increments the value of Zero_{count} by one (2712) if the value is ‘0’.

The station determines whether the new “Zero_{count}” equals a predefined number of occurrences ‘n’ (2713). If the new “Zero_{count}” equals ‘n’, the station reduces the quality of feedback by one (2714) and sets “Zero_{count}” to zero. If “zero_{count}” is not equal to ‘n’, the station maintains the quality of feedback.

Turning back to FIG. 26D, FIG. 26D shows a variation of FIG. 26C. Interpolation Adaptation 1 2631-1 indicates the interpolation adaptation for the first station. Interpolation Adaptation 2 2631-2 indicates the interpolation adaptation for the second station. This configuration continues until Interpolation Adaptation 8 2631-8 for the last station.

According to the third preferred embodiment, it is possible to improve the feedback quality much better.

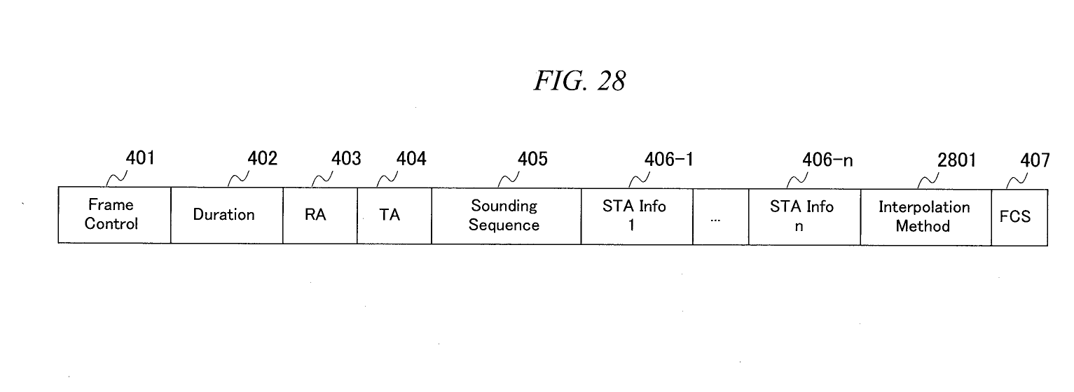

FIG. 28 shows NDPA of the fourth preferred embodiment. Compared to NDPA of the first preferred embodiment in FIG. 4A, it preferably includes a field of Interpolation Method 2801 as an extra field.

FB Poll according to the fourth preferred embodiment preferably is configured to also furnish such field.

Interpolation Method 2801 preferably is an 8 bits field, while only 2 bits are needed to state the interpolation method, for example. In Interpolation Method 2801, ‘00’ is set to a linear interpolation, ‘01’ is set to a pchip cubic interpolation, ‘10’ is set to a spline cubic interpolation and ‘11’ is reserved for future use. The other 6 bits can be used to indicate the interpolation method to be used for subsequent stations returning feedback, if they are also stated in the fields of STA Info 406-2 to 406-4. Further stations don't receive this information until FB Poll is addressed to them.

A control module incorporated in the access point according to the fourth preferred embodiment, is configured to designate a particular interpolation method which is matched to the individual station.

A station follows the same procedure as that of the first preferred embodiment.

According to the fourth preferred embodiment, an access point designates a particular interpolation method which is matched to the situation in each individual station.

In the fifth preferred embodiment, the communication system preferably includes a legacy station and legacy access point, and for example, the station 118 is replaced by a legacy station 118′ and access point 102 is replaced by an access point 102′ in FIG. 1. Namely, in the fifth preferred embodiment, the stations 111 to 117, 121 and 131 are ones according to any of the first to fourth preferred embodiments of the present invention, while the station 118′ is a legacy station. And, the access points 101 and 103 are ones according to any of the first to fourth preferred embodiments of the present invention, while the access point 102 is a legacy access point. The phrase “legacy station” indicates the station with the feedback (herein after referred to “legacy feedback”) described in M. Joham, J. Brehmer and W. Utschick, “MMSE Approaches to Multiuser Spatio-Temporal Tomlinson-Harashima Precoding” Proc. 5th Int. ITG Conf. on Source and Channel Coding, pp. 387-394, January, 2004, which is not able to understand the beacon field of “Supported Interpolation” of FIG. 3B. And, the wording “legacy access point” indicates the one with the beacon field of “Supported Interpolation”.

The legacy stations communicate with an access point using legacy action frames. The stations according to any of the first to fourth preferred embodiments may communicate with the access point making use of the interpolation optimized feedback. Additionally, the stations supporting interpolation optimized feedback could opt for using legacy feedback.

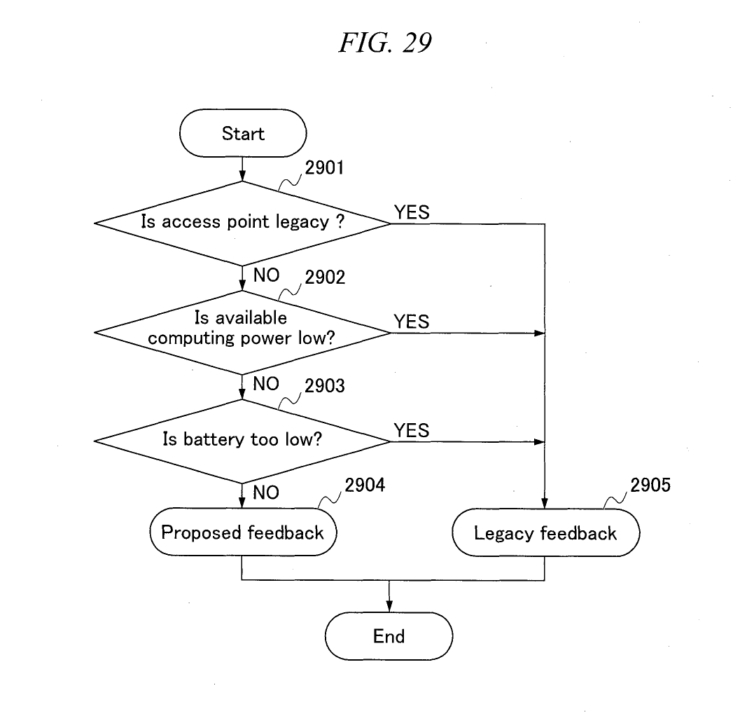

FIG. 29 shows a flowchart for stations to decide whether to use the interpolation optimized feedback or the legacy feedback.

First, a station considers if an access point supporting only legacy feedback is also intended to receive the feedback information (2901). If the judgment in step 2901 proved true, then the station will use the legacy feedback (2905). Otherwise, the station will continue to consider if the available computing power is too low to create the interpolation optimized feedback (2902). If the judgment in step 2902 proved true, then the station will use the legacy feedback (2905). Otherwise, the station will continue to consider if the battery is too low to create the interpolation optimized feedback (2903). If the judgment in step 2901 proved true, then the station will use the legacy feedback (2905). Otherwise, the station will use the interpolation optimized feedback (2904).

According to the fifth preferred embodiment, even if a legacy station or legacy access point is included in the communication system, the communication can be established. And, the station according to the present preferred embodiments could perform the legacy feedback to continue the communication with an access point.

The access point or station according to the present invention could perform any of the preferred embodiments 1 to 5 at any predetermined interval.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-10. (canceled)

11. A transmitting device configured to perform wireless communication, the transmitting device comprising:
a control module configured to indicate a method out of a plurality of interpolation methods, each of which interpolates channel values in missing subcarriers based on positions of representative subcarriers, which are selected out of subcarriers defining a frequency band used in the wireless communication, and values in the representative subcarriers; and
a transmitting module configured to transmit information about the selected interpolation method.

12. The transmitting device according to claim 11, wherein the transmitting device is configured to transmit the information about the selected interpolation method according to a channel state between the transmitting device and at least one receiving device.

13. The transmitting device according to claim 11, wherein the control module is configured to indicate several methods out of the plurality of interpolation methods, each of which interpolates the channel values in the missing subcarriers based on the positions of representative subcarriers, which are selected out of the subcarriers defining the frequency band used in the wireless communication, and the values in the representative subcarriers, and the transmitting module is configured to transmit information about the several interpolation methods selected.

14. The transmitting device according to claim 11, wherein the transmitting device is configured to perform the wireless communication with a plurality of receiving devices and the control module is configured to indicate in each of the plurality of receiving devices one of the plurality of interpolation methods, and the transmission module is configured to transmit the indicated interpolation methods.

15. The transmitting device according to claim 11, wherein the transmitting device is configured to transmit information about a maximum and/or a minimum number of the representative subcarriers.

16. The transmitting device according to claim 11, wherein the transmitting device is configured to transmit information about a quality of feedback from a receiving device to the transmitting device.

17. A receiving device configured to perform wireless communication, the receiving device comprising:
a reception module configured to receive information about a plurality of interpolation methods, each of which interpolates channel values in missing subcarriers based on positions of representative subcarriers, which are selected out of subcarriers defining a frequency band used in the wireless communication, and values in the representative subcarriers; and
an interpolation choice module configured to select a method out of the plurality of interpolation methods.

18. The receiving device according to claim 17, further comprising:
an optimum selection module configured to select representative subcarriers out of the subcarriers defining the frequency band used in the wireless communication at irregular intervals.

19. An interpolation method used in a wireless communication, the method comprising:
identifying representative subcarriers, selected out of subcarriers defining a frequency band used in the wireless communication, to channel values;
finding slopes of channel characteristics in the representative subcarriers; and
interpolating channel values in missing points by channel values, slopes and positions in the representative subcarriers.
